(19) United States
(12) Patent Application Publication
(10) Pub. No.: US 2025/0108367 A1
(43) Pub. Date: Apr. 3, 2025

(54) SAMPLE CARRIER FOR USE WITH A BODILY SAMPLE

(71) Applicant: S.D. SIGHT DIAGNOSTICS LTD., Tel Aviv (IL)

(72) Inventors: Sharon PECKER, Rehovot (IL); Noam MORALI, Rehovot (IL); Aviram STEINBOK, Moshav Hayogev (IL); Yochay Shlomo ESHEL, Sde Warburg (IL); Trevor RUGGIERO, South Portland, ME (US); Kristofer KURTIN, Wilmington, MA (US); Joseph Joel POLLAK, Neve Daniel (IL); Daniel LEVNER, Brookline, MA (US); Julie RICHARDSON, Arlington, MA (US)

(73) Assignee: S.D. SIGHT DIAGNOSTICS LTD., Tel Aviv (IL)

(21) Appl. No.: 18/832,199

(22) PCT Filed: Jan. 25, 2023
(86) PCT No.: PCT/IB2023/050621

§ 371 Date: Jul. 23, 2024

Related U.S. Application Data
(60) Provisional application No. 63/354,948, filed on Jun. 23, 2022.
(60) Provisional application No. 63/302,697, filed on Jan. 25, 2022.

(51) Int. Cl. B01L 3/00

(52) U.S. Cl. CPC B01L 3/502; B01L 2200/026; B01L 2200/16; B01L 2300/042; B01L 2300/044; B01L 2300/047; B01L 2300/0672; B01L 2400/0487

(57) ABSTRACT

Apparatus and methods are described for analyzing a bodily sample. A sample carrier (22), which houses the bodily sample, includes at least one fluidic channel (120), at least one analysis chamber (68), and a receptacle (92) that houses a diluent. A pump system (150) pumps the diluent from the receptacle (92) into the fluidic channel (120) in a first fluid flow direction, and subsequently, pumps the diluent and the bodily sample in a second fluid flow direction, which is a reverse of the first fluid flow direction, to thereby mix the diluent and the bodily sample within the receptacle (92). Other applications are also described.

### CROSS-REFERENCE TO RELATED APPLICATIONS

The present application claims priority from U.S. Provisional Patent Application No. 63/302,697 to Pecker, filed Jan. 25, 2022, entitled “Sample carrier for use with a bodily sample,” and from U.S. Provisional Patent Application No. 63/354,948 to Pecker, filed Jun. 23, 2022, entitled “Sample carrier for use with a bodily sample”. Both of the aforementioned US Provisional applications are incorporated herein by reference.

### FIELD OF EMBODIMENTS OF THE INVENTION

Some applications of the presently disclosed subject matter relate generally to analysis of bodily samples, and, in particular, to optical density and microscopic measurements that are performed upon blood and fine needle aspirate samples.

### BACKGROUND

In some optics-based methods (e.g., diagnostic, and/or analytic methods), a property of a bodily sample, such as a blood sample, is determined by performing an optical measurement. For example, the concentration and/or density of a component (e.g., a count of the component per unit volume) may be determined by counting the component within a microscopic image. Similarly, the concentration and/or density of a component may be measured by performing optical absorption, transmittance, fluorescence, and/or luminescence measurements upon the sample. Typically, the sample is placed into a sample carrier and the measurements are performed with respect to a portion of the sample that is contained within an analysis chamber of the sample carrier. The measurements that are performed upon the portion of the sample that is contained within the chamber of the sample carrier are analyzed in order to determine a property of the sample.

### SUMMARY OF EMBODIMENTS

In accordance with some applications of the present invention, a sample carrier includes a main body and a cap. The cap is typically placed onto the main body of the sample carrier after the sample has been received by the sample carrier. Typically, the cap is configured to become irreversibly coupled to the main body of the sample carrier by being placed onto the main body of the sample carrier. Typically, the sample carrier defines a plurality of ports. Further typically, the sample carrier includes one or more analysis chambers, for example, a microscope analysis chamber, and an optical-density analysis chamber. For some applications, the analysis chambers are recessed with respect to an outer surface of the sample carrier. For some such applications, one or more protective ribs are disposed between the analysis chambers, in order to prevent a user from touching outer surfaces of the analysis chambers.

For some applications, the sample carrier is used when analyzing a bodily sample. For some applications, the sample is a blood sample that includes blood or components thereof (e.g., a diluted or non-diluted whole blood sample, a sample including predominantly red blood cells, or a diluted sample including predominantly red blood cells), and parameters are determined relating to components in the blood such as platelets, white blood cells, anomalous white blood cells, circulating tumor cells, red blood cells, reticulocytes, Howell-Jolly bodies, sickle cells, teardrop cells, etc. For some applications, the sample is a blood sample, and the sample is analyzed such as to perform a complete blood count. For some applications, the sample includes a fine needle aspirate. For some such applications, parameters are determined relating to components in the sample such as: macrophages, histiocytes, mast cells, plasma cells, melanocytes, epithelial cells, mesenchymal cells, mesothelial cells, bacteria, yeast, and/or parasites. It is noted that the sample may be a human bodily sample or an animal bodily sample.

For some such applications, the sample carrier is used with an optical measurement unit that includes a pump system, which is configured to pump fluid through fluidic channels defined by the sample carrier. For some applications, a first portion of the sample is pumped into the microscope analysis chamber, and a second portion of the sample is pumped into the optical-density analysis chamber.

Typically, a first capillary tube and a second capillary tube protrude from the main body of the sample carrier. The user typically places the bodily sample into the sample carrier via the capillary tubes. For some applications, an end of the capillary tube that is within the sample carrier is disposed adjacent to a relatively wide cavity, which acts as a capillary break and prevents the sample from flowing further in the absence of pressure being applied to the sample. Thus, in the absence of positive pressure being used to pump the sample out of the capillary tube and into the fluidic channels within the sample carrier, the sample typically fills up the lumen of the capillary tube and remains stored within the lumen. Typically, the user places the cap onto the main body of the sample carrier after the sample has been placed into the capillary tubes. Further typically, placement of the cap onto the main body of the sample carrier seals the sample within the main body of the sample carrier. For some applications, the cap is configured such that upon being placed onto the main body of the sample carrier, the cap becomes irreversibly coupled to the sample carrier, such that the bodily sample becomes irreversibly sealed within the sample carrier, thereby preventing contamination of the sample carrier.

For some applications, a puncture needle protrudes from the inner surface of the cap. The puncture needle is configured to puncture a blister pack that is disposed within the main body of the sample carrier, as the cap is placed onto the main body of the sample carrier. For some applications, the blister pack comprises a receptacle that houses the diluent that is used to dilute the first portion of the bodily sample (which is pumped to a microscope analysis chamber). Typically, the puncture needle is configured to puncture the blister pack and to thereby place the diluent that is housed within the blister into fluid communication with a fluidic channel that is defined by the cap. The puncturing of the blister pack by the puncture needle typically places the diluent into fluid communication with the first portion of the bodily sample, via the fluidic channel, which extends through the cap. Thus, placing the cap on the main body of the sample carrier not only punctures the blister pack, but also places the diluent into fluid communication with the first portion of the bodily sample. For some applications, stains are housed within the cap in a dry form and positioned such that it is difficult for a user to tamper with the stains. For example, the stains may be housed along the fluidic channel defined by the cap. The cap is configured such that as the diluent flows out of the blister pack, the diluent mixes with the stain and the diluent and the stain then mix with the bodily sample. Thus, placing the cap on the main body of the sample carrier not only punctures the blister pack, and places the diluent into fluid communication with the first portion of the bodily sample, but also causes the stain to mix with the diluent and the first portion of the bodily sample.

For some applications, the blister pack is disposed within the sample carrier at an angle (i.e., a non-zero angle) to the base surface of the analysis chambers. Typically, in this manner, the blister pack acts as a bubble trap whereby any air that enters fluidic channels that are in fluid communication with the blister pack flows to the upper end of the blister pack, which is disposed remotely from a puncture region of the blister pack. For some applications, the blister pack is initially used to store the diluent (typically in a sealed manner), and is subsequently used as a mixing chamber for mixing of the diluent and the sample. It is noted that using the blister pack (or the other receptacle that is initially used for storing the diluent) as a mixing chamber may reduce the volume of the sample carrier, relative to a similar sample carrier that utilizes a separate mixing chamber to perform this function of the blister pack.

In general, it is noted that although some applications of the present invention are described with respect to a blood sample, the scope of the present invention includes applying the apparatus and methods described herein to a variety of samples. For some applications, the sample is a fine needle aspirate. For some applications, the sample is a bodily sample, such as, blood, saliva, semen, sweat, sputum, vaginal fluid, stool, breast milk, bronchoalveolar lavage, gastric lavage, tears and/or nasal discharge. The bodily sample may be from any living creature, and is typically from warm blooded animals. For some applications, the bodily sample is a sample from a mammal, e.g., from a human body. For some applications, the sample is taken from any domestic animal, zoo animals and farm animals, including but not limited to dogs, cats, horses, cows and sheep. Alternatively or additionally, the bodily sample is taken from animals that act as disease vectors including deer or rats.

For some applications, similar techniques to those described herein are applied to a non-bodily sample. For some applications, the sample is an environmental sample, such as, a water (e.g., groundwater) sample, surface swab, soil sample, air sample, or any combination thereof. In some embodiments, the sample is a food sample, such as, a meat sample, dairy sample, water sample, wash-liquid sample, beverage sample, and/or any combination thereof.

There is therefore provided, in accordance with some applications of the present invention, apparatus for analyzing a bodily sample, the apparatus including:
a sample carrier configured to house the bodily sample, the sample carrier including at least one fluidic channel, at least one analysis chamber, and a receptacle that houses a diluent; and
a pump system configured to:
   pump the diluent from the receptacle into the fluidic channel in a first fluid flow direction, and
   subsequently, pump the diluent and the bodily sample in a second fluid flow direction, which is a reverse of the first fluid flow direction, to thereby mix the diluent and the bodily sample within the receptacle.

In some applications, the sample carrier is configured to be placed within an optical measurement unit that is configured to perform an optical measurement upon the bodily sample while the sample carrier is disposed within the optical measurement unit, and the pump system is disposed within the optical measurement unit.

In some applications, the fluidic channel and the receptacle are configured such that, as the diluent and the bodily sample are pumped in the second fluid flow direction, the diluent and the bodily sample are pumped from a smaller cross-sectional area within the fluidic channel into a larger cross-sectional area within the receptacle, thereby enhancing mixing of the diluent and the bodily sample.

In some applications, the fluidic channel is configured such that, as the diluent and the bodily sample are pumped in the first fluid flow direction, the diluent and the bodily sample are pumped from a smaller cross-sectional area within the fluidic channel into a larger cross-sectional area within the fluidic channel, thereby enhancing mixing of the diluent and the bodily sample.

In some applications, the receptacle includes a blister pack and the sample carrier includes a needle that is configured to release the diluent from the blister pack, by piercing the blister pack.

In some applications, the blister pack is disposed at an angle within the sample carrier such that the blister pack acts as a bubble trap, by preventing air from being pumped from the blister pack.

In some applications, the needle is hollow and the fluidic channel extends through the needle.

In some applications, the sample carrier includes a cap and a main body, the blister pack is disposed within the main body, and the needle is coupled to the cap and is configured to pierce the blister pack as the cap is coupled to the main body of the sample carrier.

In some applications, the fluidic channel extends from the blister pack through the cap and back into the main body of the sample carrier.

In some applications, the apparatus further includes one or more stains that are configured to stain the bodily sample and that are disposed within the cap, and the cap is configured such that as the diluent flows out of the blister pack, the diluent mixes with the stain and the diluent and the stain mix with the bodily sample.

There is further provided, in accordance with some applications of the present invention, apparatus for analyzing a bodily sample, the apparatus including:
a sample carrier configured to house the bodily sample, the sample carrier including at least one fluidic channel, and at least one analysis chamber; and
an optical measurement unit including:
   a stage that is configured to hold the sample carrier;
   an optical measurement device that is configured to perform optical measurements on a portion of the bodily sample that is disposed in the analysis chamber, when the sample carrier is held by the stage; and
   a pump system including one or more pumps that are configured to pump the bodily sample through the fluidic channel.

In some applications, the pump system is configured to apply any one of ambient pressure, positive pressure, vacuum pressure, or to apply no pressure to the fluidic channel.

In some applications, the sample carrier includes a microscope analysis chamber and a first fluidic channel that extends to the microscope analysis chamber, and the optical measurement device includes a microscope configured to image a first portion of the bodily sample, when the first portion of the bodily sample is disposed within the microscopic analysis chamber.

In some applications, the pump system is configured to pump the first portion of the bodily sample through the first fluidic channel in forward and reverse directions.

In some applications:
the sample carrier includes an optical-density-analysis chamber and a second fluidic channel that extends to the optical-density-analysis chamber;
the optical measurement device further includes an optical-density-measurement device configured to perform optical density measurements on a second portion of the bodily sample, when the second portion of the bodily sample is disposed within the optical-density-analysis chamber; and
the pump system is configured to pump the first and second portions of the bodily sample through the first and second fluidic channels respectively.

In some applications, the pump system is configured to pump each of the first and second portions of the bodily sample through the first and second fluidic channels respectively, in forward and reverse directions.

In some applications, the microscope analysis chamber includes an inlet and an outlet, the sample carrier further includes a third fluidic channel, and the pump system is configured to balance pressure between the inlet and the outlet of the microscope analysis chamber via the first and third fluidic channels.

In some applications, the microscope analysis chamber includes an inlet and an outlet, the sample carrier includes an additional fluidic channel, and the pump system is configured to balance pressure between the inlet and the outlet of the microscope analysis chamber via the first fluidic channel and the additional fluidic channel.

In some applications, the pump system is configured to balance pressure between the inlet and the outlet of the microscope analysis chamber by exposing the first fluidic channel and the additional fluidic channel to atmospheric pressure.

In some applications, the pump system is configured to balance pressure between the inlet and the outlet of the microscope analysis chamber by applying equal amounts of pressure via the first fluidic channel and the additional fluidic channel.

In some applications, the pump system includes a volumetric pump system that includes a piston that is configured to pump defined volumes of air through the fluidic channel.

In some applications, the pump system includes a relative pressure gauge that is configured to measure pressure of a portion of the pump system relative to ambient pressure, and the optical measurement unit includes a computer processor that is configured to derive ambient pressure from the pressure that is measured by the relative pressure gauge.

In some applications, the computer processor is configured to determine a volume that should be pumped by the piston in order to provide a desired pressure change, based upon the ambient pressure.

There is further provided, in accordance with some applications of the present invention, apparatus for analyzing a bodily sample, the apparatus including:
a sample carrier including:
   a main body that defines at least one analysis chamber; and
   a cap configured to be coupled to the main body by a user, and to thereby seal the bodily sample within the sample carrier; and
an optical measurement unit including:
   a stage that is configured to hold the sample carrier;
   an optical measurement device that is configured to perform optical measurements on a portion of the bodily sample that is disposed in the analysis chamber, when the sample carrier is held by the stage,
   the cap being configured to provide an interface between the optical measurement unit and the main body of the sample carrier.

In some applications, the sample carrier includes one or more capillary tubes that are configured to transfer the bodily sample into the sample carrier via capillary forces.

In some applications, the cap is configured to be coupled to the main body of the sample carrier such that if the cap is tampered with subsequent to being coupled to the main body of the sample carrier the tampering is detectable.

In some applications, the sample carrier includes a blister pack housed within the main body of the sample carrier, the blister pack containing a diluent, and the cap includes a needle that is configured to release the diluent from the blister pack by piercing the blister pack.

In some applications, the blister pack is disposed at an angle within the sample carrier such that the blister pack acts as a bubble trap, by preventing air from being pumped from the blister pack.

In some applications, the sample carrier is configured to define a fluidic channel that extends from the blister pack through the cap and back into the main body of the sample carrier.

In some applications, the apparatus further includes one or more stains that are configured to stain the bodily sample and that are disposed within the cap, and the cap is configured such that as the diluent flows out of the blister pack, the diluent mixes with the stain and the diluent and the stain mix with the bodily sample.

In some applications, the optical measurement unit includes a pump system, the sample carrier defines one or more fluidic channels, and the cap is configured to provide an interface between the pump system and the one or more fluidic channels.

In some applications, the pump system is configured to apply any one of ambient pressure, positive pressure, vacuum pressure, or to apply no pressure to the one or more fluidic channels.

In some applications, the sample carrier includes a microscope analysis chamber and a first fluidic channel that extends from the first port to the microscope analysis chamber, and the optical measurement device includes a microscope configured to image a first portion of the bodily sample, when the first portion of the bodily sample is disposed within the microscopic analysis chamber.

In some applications, the pump system is configured to pump the first portion of the bodily sample through the first fluidic channel in forward and reverse directions.

In some applications, the microscope analysis chamber includes an inlet and an outlet, the sample carrier includes an additional fluidic channel, and the pump system is configured to balance pressure between the inlet and the outlet of the microscope analysis chamber via the first fluidic channel and the additional fluidic channel.

In some applications, the pump system is configured to balance pressure between the inlet and the outlet of the microscope analysis chamber by exposing the first fluidic channel and the additional fluidic channel to atmospheric pressure.

In some applications, the pump system is configured to balance pressure between the inlet and the outlet of the microscope analysis chamber by balancing pressure applied via the first fluidic channel and the additional fluidic channel.

In some applications, the sample carrier includes an optical-density-analysis chamber and a second fluidic channel that extends to the optical-density-analysis chamber, and the optical measurement device further includes an optical-density-measurement device configured to perform optical density measurements on a second portion of the bodily sample, while the second portion of the bodily sample is disposed within the optical-density-analysis chamber; and
the pump system is configured to pump the first and second portions of the bodily sample through the first and second fluidic channels respectively.

In some applications, the pump system is configured to pump each of the first and second portions of the bodily sample through the first and second fluidic channels respectively, in forward and reverse directions.

In some applications, the microscope analysis chamber includes an inlet and an outlet, and the sample carrier further includes a third fluidic channel, and the pump system is configured to balance pressure between the inlet and the outlet of the microscope analysis chamber via the first and third fluidic channels.

In some applications, the pump system is a volumetric pump system that includes a piston that is configured to pump defined volumes of air through the fluidic channel.

In some applications, the pump system includes a relative pressure gauge that is configured to measure pressure of a portion of the pump system relative to ambient pressure, and the optical measurement unit includes a computer processor that is configured to derive ambient pressure from the pressure that is measured by the relative pressure gauge.

In some applications, the computer processor is configured to determine a volume that should be pumped by the piston in order to provide a desired pressure change, based upon the ambient pressure.

There is further provided, in accordance with some applications of the present invention, apparatus for performing measurement on a bodily sample, the apparatus including:
a sample carrier configured to house the bodily sample, the sample carrier including:
   at least one analysis chamber having an inlet and an outlet;
   first and second ports;
   a first fluidic channel extending between the inlet of the analysis chamber and the first port; and
   and a second fluidic channel extending between the outlet of the analysis chamber and the second port; and
a pump system configured to:
   pump the bodily sample into the analysis chamber by pumping via the first port; and
   subsequently, maintain the bodily in a settled stated within the analysis chamber by balancing pressure between the inlet and outlet of the analysis chamber.

In some applications, the pump system is configured to apply any one of ambient pressure, positive pressure, vacuum pressure, or to apply no pressure via either one of the first and second fluidic channels.

In some applications, the pump system is configured to balance pressure between the inlet and outlet of the analysis chamber by exposing both the first port and the second port to atmospheric pressure.

In some applications, the pump system is configured to balance pressure between the inlet and outlet of the analysis chamber by applying equal amounts of pressure via the first port and the second port.

In some applications, the pump system is configured to pump the bodily sample through the first fluidic channel in forward and reverse directions.

In some applications, the sample carrier further includes a receptacle that houses a diluent and the pump system is configured to:
pump a mixture of the bodily sample and the diluent from the receptacle into the analysis chamber by pumping via the first port; and
subsequently, maintain the mixture in a settled stated within the analysis chamber by balancing pressure between the inlet and outlet of the analysis chamber.

In some applications, the receptacle is configured to undergo changes in volume that apply pressure to the mixture in the analysis chamber via the first fluidic channel, and the pump system is configured to maintain the mixture in the settled stated within the analysis chamber by pumping a predetermined volume of fluid via the second port and the second fluidic channel such as to counteract the pressure that is applied to the mixture in the analysis chamber via the first portion of the first fluidic channel.

In some applications, the analysis chamber includes a microscope analysis chamber and the optical measurement device includes a microscope configured to image a first portion of the bodily sample, when the first portion of the bodily sample is disposed within the microscopic analysis chamber.

In some applications:
the sample carrier further includes an optical-density-analysis chamber and a third fluidic channel that extends to the optical-density-analysis chamber, and the optical measurement device further includes an optical-density-measurement device configured to perform optical density measurements on a second portion of the bodily sample, when the second portion of the bodily sample is disposed within the optical-density-analysis chamber; and
the pump system is configured to pump the first and second portions of the bodily sample through the first and second fluidic channels respectively.

In some applications, the pump system is configured to pump each of the first and second portions of the bodily sample through the first and second fluidic channels respectively, in forward and reverse directions.

In some applications, the pump system is a volumetric pump system that includes a piston that is configured to pump defined volumes of air through the fluidic channel.

In some applications, the pump system includes a relative pressure gauge that is configured to measure pressure of a portion of the pump system relative to ambient pressure, and the optical measurement unit includes a computer processor that is configured to derive ambient pressure from the pressure that is measured by the relative pressure gauge.

In some applications, the computer processor is configured to determine a volume that should be pumped by the piston in order to provide a desired pressure change based upon the ambient pressure.

There is further provided, in accordance with some applications of the present invention, apparatus for performing measurement on a bodily sample, the apparatus including:
a sample carrier configured to house the bodily sample, the sample carrier including:
   a first substrate configured to define a first set of one or more fluidic channels;
   a second substrate configured to define a second set of one or more fluidic channels;
   an adhesive that bonds the first substrate to the second substrate such that there is at least some overlap between first set of fluidic channels and the second set of fluidic channels.

In some applications, the adhesive includes a pressure-sensitive adhesive.

In some applications, the sample carrier further includes one or more capillary tubes that are configured to transfer the bodily sample into at least one of the first and second sets of fluidic channels, via capillary forces.

In some applications, the sample carrier includes a first port and a microscope analysis chamber in which a first portion of the bodily sample is configured to be housed while microscopic analysis is performed on the first portion of the bodily sample, and the first set of one or more fluidic channels extend from the first port to the microscope analysis chamber.

In some applications, the sample carrier further includes a receptacle that houses a diluent, and the first set of one or more fluidic channels is configured to place the diluent in fluid communication with the microscope analysis chamber.

In some applications, the apparatus further includes a pump system, the microscope analysis chamber includes an inlet and an outlet, and the pump system is configured to balance pressure between the inlet and the outlet of the microscope analysis chamber via the first and second sets of fluidic channels.

In some applications, the sample carrier includes a second port and an optical-density-analysis chamber in which a second portion of the bodily sample is configured to be housed while optical density measurements are performed on a second portion of the bodily sample, and the second set of one or more fluidic channels extend from the second port to the optical-density-analysis chamber.

In some applications, the sample carrier includes:
a main body that defines the at least one analysis chamber; and
a cap configured to be coupled to the main body by a user, and to thereby seal the bodily sample within the sample carrier; and

In some applications, the cap is configured to be coupled to the main body of the sample carrier such that if the cap is tampered with subsequent to being coupled to the main body of the sample carrier the tampering is detectable.

In some applications, the sample carrier includes a blister pack housed within the main body of the sample carrier, the blister pack containing a diluent, and the cap includes a needle that is configured to release the diluent from the blister pack by piercing the blister pack.

In some applications, the blister pack is disposed at an angle within the sample carrier such that the blister pack acts as a bubble trap, by preventing air from being pumped from the blister pack.

In some applications, the apparatus further includes an optical measurement unit that includes:
a stage that is configured to hold the sample carrier;
an optical measurement device that is configured to perform optical measurements on a portion of the bodily sample that is disposed in the analysis chamber, when the sample carrier is held by the stage,
the cap being configured to provide an interface between the optical measurement unit and the main body of the sample carrier.

In some applications, the optical measurement unit includes a pump system, and the cap is configured to provide an interface between the pump system and at least a portion of the fluidic channels that are defined by the sample carrier.

In some applications, the sample carrier includes a blister pack housed within the main body of the sample carrier, the blister pack containing a diluent, and the cap includes a needle that is configured to release the diluent from the blister pack by piercing the blister pack.

In some applications, at least one of the fluidic channels extends from the blister pack through the cap and back into the main body of the sample carrier.

In some applications, the apparatus further includes one or more stains that are configured to stain the bodily sample and that are disposed within the cap in a dry form, and the cap is configured such that as the diluent flows out of the blister pack, the diluent mixes with the stain and the diluent and the stain mix with the bodily sample.

There is further provided, in accordance with some applications of the present invention, apparatus for analyzing a bodily sample, the apparatus including:
a sample carrier configured to house the bodily sample, the sample carrier including:
a main body that defines at least one fluidic channel via which the bodily sample is configured to flow, and at least one viewing chamber, the main body including a receptacle that houses a diluent that is configured to dilute the bodily sample; and
a cap configured to be coupled to the main body of the sample carrier by a user, and to thereby place the diluent in fluid communication with the fluidic channel.

There is further provided, in accordance with some applications of the present invention, apparatus for analyzing a bodily sample, the apparatus including:
a sample carrier configured to house the bodily sample, the sample carrier including:
a main body that defines at least one fluidic channel via which the bodily sample is configured to flow, and at least one viewing chamber, the main body including a receptacle that houses a diluent that is configured to dilute the bodily sample;
a cap configured to be coupled to the main body of the sample carrier by a user; and
one or more stains disposed in the cap and configured to stain the bodily sample.

There is further provided, in accordance with some applications of the present invention, apparatus for analyzing a bodily sample, the apparatus including:
a sample carrier configured to house the bodily sample, the sample carrier including at least one analysis chamber, a receptacle that houses a diluent, and a fluidic channel between the receptacle and the analysis chamber; and
a pump configured to pump the diluent from the receptacle into the fluidic channel,
the fluidic channel including a plurality of portions having respective cross-sectional areas, which are configured such that as the bodily sample and the diluent are pumped between the portions of the fluidic channel the bodily sample and the diluent are mixed with each other.

There is further provided, in accordance with some applications of the present invention, apparatus for analyzing a bodily sample, the apparatus including:
a sample carrier configured to house the bodily sample, the sample carrier including at least one fluidic channel, at least one analysis chamber, and a receptacle that houses a diluent; and
a volumetric pump configured to:
   cyclically pump a first predetermined volume of fluid into and out of the fluidic channel to thereby form a mixture of the diluent and the bodily sample, and
   subsequently, pump a second predetermined volume of fluid out of the fluidic channel to fill the analysis chamber with the mixture of the diluent and the bodily sample.

There is further provided, in accordance with some applications of the present invention, apparatus for analyzing a bodily sample, the apparatus including:
a sample carrier configured to house the bodily sample, the sample carrier including at least one fluidic channel, at least one analysis chamber, and a receptacle that houses a diluent; and
an optical measurement unit including:
   a stage that is configured to hold the sample carrier such that a base surface of the analysis chamber is disposed in a horizontal orientation; and
   an optical measurement device that is configured to perform optical measurements on a portion of the bodily sample that is disposed in the analysis chamber, when the sample carrier is held by the stage,
   a base of the receptacle being disposed within the sample carrier at an angle to the base surface of the analysis chamber, such that the receptacle acts as a bubble trap.

There is further provided, in accordance with some applications of the present invention, apparatus for performing measurement on a bodily sample, the apparatus including:
a sample carrier configured to house the bodily sample, the sample carrier including:
   at least one analysis chamber;
   a receptacle that houses a diluent;
   first and second ports;
   a first fluidic channel including a first portion that extends between the receptacle and an inlet of the analysis chamber and a second portion that extends between an outlet of the analysis chamber and the first port; and
   a second fluidic channel extending between the inlet of the analysis chamber and the second port; and
a pump system configured to:
   pump a mixture of the bodily sample and the diluent from the receptacle into the analysis chamber by pumping a fluid via the first port; and
   subsequently, maintain the mixture in a settled stated within the analysis chamber by balancing pressure between the inlet and outlet of the analysis chamber.

In some applications, the pump system is configured to maintain the mixture in the settled stated within the analysis chamber by exposing both the first port and the second port to atmospheric pressure.

In some applications, the receptacle is configured to undergo changes in volume that apply pressure to the mixture in the analysis chamber via the first fluidic channel, and the pump system is configured to maintain the mixture in the settled stated within the analysis chamber by pumping a predetermined volume of fluid via the second port and the second fluidic channel such as to counteract the pressure that is applied to the mixture in the analysis chamber via the first portion of the first fluidic channel.

There is further provided, in accordance with some applications of the present invention, apparatus for performing measurement on a bodily sample, the apparatus including:
a sample carrier configured to house the bodily sample, the sample carrier including:
   at least one analysis chamber;
   a capillary tube configured to receive the bodily sample;
   a fluidic channel between the capillary tube and the analysis chamber; and
a pump system configured to cyclically pump the bodily sample in forward and reverse directions from the capillary tube to the analysis chamber and to apply the cyclical pumping such that there is net flow of the bodily sample from the capillary tube to the analysis chamber.

There is further provided, in accordance with some applications of the present invention, apparatus for performing measurement on a bodily sample, the apparatus including:
a sample carrier configured to house the bodily sample, the sample carrier including:
   at least one analysis chamber;
   a capillary tube configured to receive the bodily sample;
   a fluidic channel between the capillary tube and the analysis chamber; and
a pump system configured to pump the bodily sample from the capillary tube to the analysis chamber and to cyclically vary a speed at which the bodily sample is pumped from the capillary tube to the analysis chamber through fast and slow pumping periods.

There is further provided, in accordance with some applications of the present invention, apparatus for performing measurement on a bodily sample, the apparatus including:
a sample carrier configured to house the bodily sample, the sample carrier including:
   at least one analysis chamber;
   a capillary tube configured to receive the bodily sample;
   a fluidic channel between the capillary tube and the analysis chamber,
   at an inlet region of the analysis chamber a height of the analysis chamber increasing in a gradual manner that is uniform across a width of the analysis chamber, to thereby encourage uniform filling of the analysis chamber.

There is further provided, in accordance with some applications of the present invention, apparatus for performing measurement on a bodily sample, the apparatus including:
a sample carrier configured to house the bodily sample, the sample carrier including:
   at least one analysis chamber having an inlet at a first end and an outlet at a second end;
   a capillary tube configured to receive the bodily sample;
   a first fluidic channel between the capillary tube and the inlet of the analysis chamber; and
   a second fluidic channel extending from the outlet of the analysis chamber;
   a height of an outlet region of the analysis chamber, which is disposed adjacent to the outlet, being less than a height of a central region of the analysis chamber, to thereby encourage uniform filling of the central region analysis chamber.

There is further provided, in accordance with some applications of the present invention, apparatus for performing measurement on a bodily sample, the apparatus including:
a sample carrier configured to house the bodily sample, the sample carrier including:
   at least one analysis chamber;
   a capillary tube configured to receive the bodily sample;
   a fluidic channel between the capillary tube and the analysis chamber,
   the sample carrier defining one or more gutters along the analysis chamber that have higher fluidic resistance than a central region of the analysis chamber and that are configured to encourage uniform filling of the central region of the analysis chamber by the bodily sample by maintaining an open air path along the analysis chamber as the central region of the analysis chamber fills.

The present invention will be more fully understood from the following detailed description of embodiments thereof, taken together with the drawings, in which:

### BRIEF DESCRIPTION OF THE DRAWINGS

FIG. 1 is a block diagram showing components of a bodily sample analysis system, in accordance some applications of the present invention;

FIGS. 2A and 2B are schematic illustrations of an optical measurement unit, in accordance with some applications of the present invention;

FIGS. 3A and 3B are schematic illustrations of respective views of a sample carrier that is used for performing both microscopic measurements and optical density measurements, in accordance with some applications of the present invention;

FIG. 3C is a schematic illustration of a microscope analysis chamber and an optical-density analysis chamber of a sample carrier, in accordance with some applications of the present invention;

FIGS. 4A and 4B are schematic illustrations of portions of a sample carrier prior to a cap being applied to the main body of the sample carrier, in accordance with some applications of the present invention;

FIGS. 4C, 4D, 4E, and 4F are schematic illustrations of an adaptor for placing a bodily sample in fluid communication with a capillary tube of a sample carrier, in accordance with some applications of the present invention;

FIGS. 5A. 5B, 5C, and 5D are schematic illustrations of a cap of a sample carrier, in accordance with some applications of the present invention;

FIGS. 6A and 6B are schematic illustrations of a cap being placed on a main body of a sample carrier, in accordance with some applications of the present invention;

FIGS. 7A and 7B are schematic illustrations of a blister pack of a sample carrier, in accordance with some applications of the present invention;

FIG. 8 is a schematic illustration of fluidic channels through a sample carrier, in accordance with some applications of the present invention;

FIG. 9 is a schematic illustration of a microscope analysis chamber and an optical-density analysis chamber of a sample carrier, in which features of the microscope analysis chamber are shown, in accordance with some applications of the present invention; and

FIGS. 10A, 10B, and 10C are schematic illustrations of portions of a pump system that is configured to interact with the fluidic channels of the sample carrier, in accordance with some applications of the present invention.

### DETAILED DESCRIPTION OF EMBODIMENTS

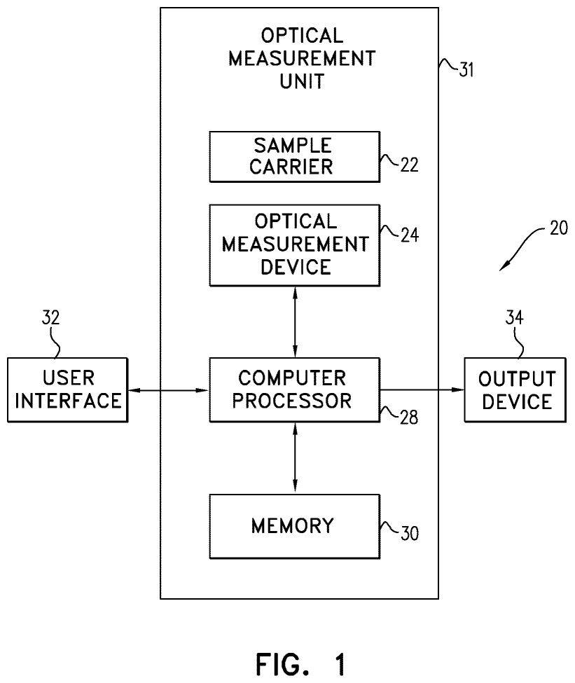

Reference is now made to FIG. 1, which is block diagram showing components of a bodily sample analysis system 20, in accordance with some applications of the present invention. Typically, a bodily sample (e.g., a blood sample or a fine needle aspirate) is placed into a sample carrier 22. While the sample is disposed in the sample carrier, optical measurements are performed upon the sample using one or more optical measurement devices 24. For example, the optical measurement devices may include a microscope (e.g., a digital microscope), a spectrophotometer, a photometer, a spectrometer, a camera, a spectral camera, a hyperspectral camera, a fluorometer, a spectrofluorometer, and/or a photodetector (such as a photodiode, a photoresistor, and/or a phototransistor). For some applications, the optical measurement devices include dedicated light sources (such as light emitting diodes, incandescent light sources, etc.) and/or optical elements for manipulating light collection and/or light emission (such as lenses, diffusers, filters, etc.).

A computer processor 28 typically receives and processes optical measurements that are performed by the optical measurement device. Further typically, the computer processor controls the acquisition of optical measurements that are performed by the one or more optical measurement devices. The computer processor communicates with a memory 30. A user (e.g., a laboratory technician, a healthcare professional, or an individual from whom the sample was drawn) sends instructions to the computer processor via a user interface 32. For some applications, the user interface includes a keyboard, a mouse, a joystick, a touchscreen device (such as a smartphone or a tablet computer), a touchpad, a trackball, a voice-command interface, and/or other types of user interfaces that are known in the art. Typically, the computer processor generates an output via an output device 34. Further typically, the output device includes a display, such as a monitor, and the output includes an output that is displayed on the display. For some applications, the processor generates an output on a different type of visual, text, graphics, tactile, audio, and/or video output device, e.g., speakers, headphones, a smartphone, or a tablet computer. For some applications, user interface 32 acts as both an input interface and an output interface, i.e., it acts as an input/output interface. For some applications, the processor generates an output on a computer-readable medium (e.g., a non-transitory computer-readable medium), such as a disk, or a portable USB drive, and/or generates an output on a printer.

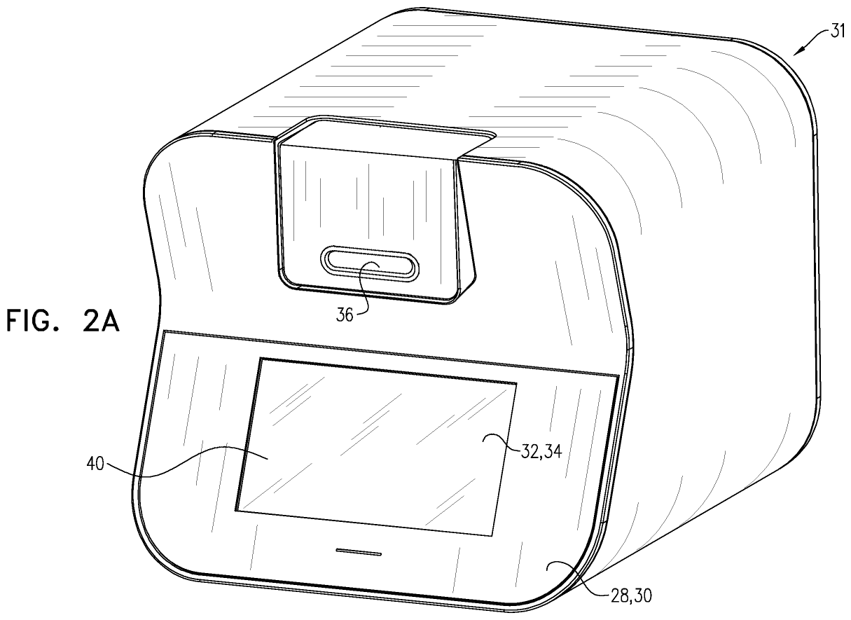

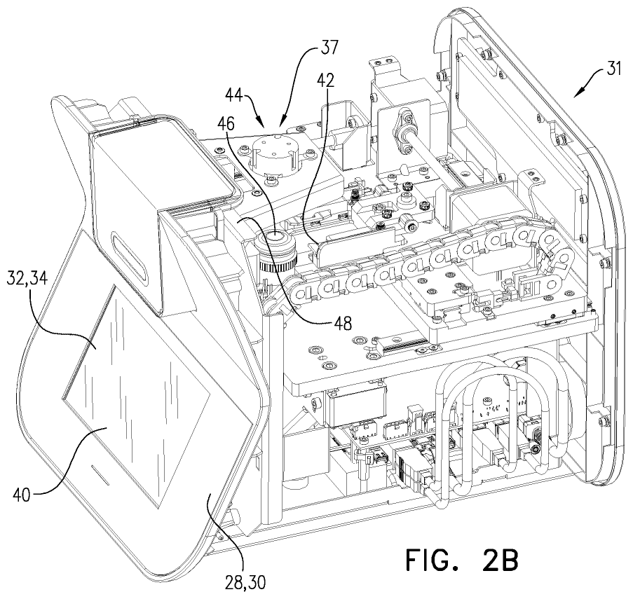

Reference is now made to FIGS. 2A and 2B, which are schematic illustrations of an optical measurement unit 31, in accordance with some applications of the present invention. FIG. 2A shows an oblique view of the exterior of the fully assembled device, while FIG. 2B shows an oblique view of the device with the cover having been made transparent, such that components within the device are visible. For some applications, the one or more optical measurement devices 24 (and/or computer processor 28 and memory 30) are housed inside optical measurement unit 31. In order to perform the optical measurements upon the sample, sample carrier 22 is placed inside the optical measurement unit. For example, the optical measurement unit may define a slot 36, via which the sample carrier is inserted into the optical measurement unit. Typically, the optical measurement unit includes a stage 42, which is configured to support sample carrier 22 within the optical measurement unit. For some applications, a screen 40 on the cover of the optical measurement unit (e.g., a screen on the front cover of the optical measurement unit, as shown) functions as user interface 32 and/or output device 34.

Typically, the optical measurement unit includes microscope system 37 (shown in FIG. 2B) configured to perform microscopic imaging of a portion of the sample. For some applications, the microscope system includes a set of light sources 44 (which typically include a set of brightfield light sources (e.g., light emitting diodes) that are configured to be used for brightfield imaging of the sample, and a set of fluorescent light sources (e.g., light emitting diodes) that are configured to be used for fluorescent imaging of the sample), and a camera (e.g., a CCD camera, or a CMOS camera) configured to image the sample. For some applications, the microscope system includes an objective lens 46. Typically, the optical measurement unit also includes an optical-density-measurement device 48 (shown in FIG. 2B) configured to perform optical density measurements (e.g., optical absorption measurements) on a second portion of the sample. For some applications, the optical-density-measurement device includes a set of optical-density-measurement light sources (e.g., light emitting diodes) and light detectors, which are configured for performing optical density measurements on the sample. For some applications, each of the aforementioned sets of light sources (i.e., the set of brightfield light sources, the set of fluorescent light sources, and the set optical-density-measurement light sources) includes a plurality of light sources (e.g., a plurality of light emitting diodes), each of which is configured to emit light at a respective wavelength or at a respective band of wavelengths.

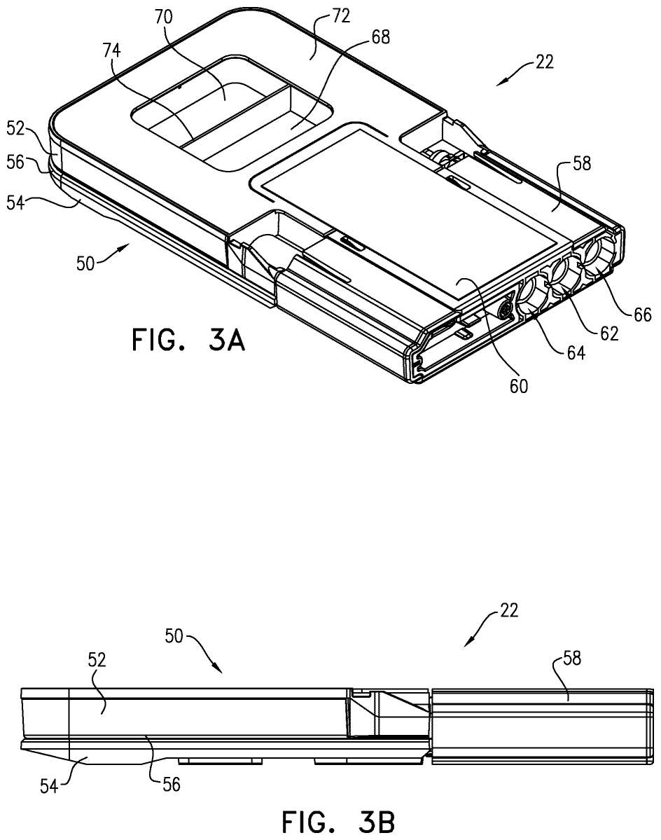

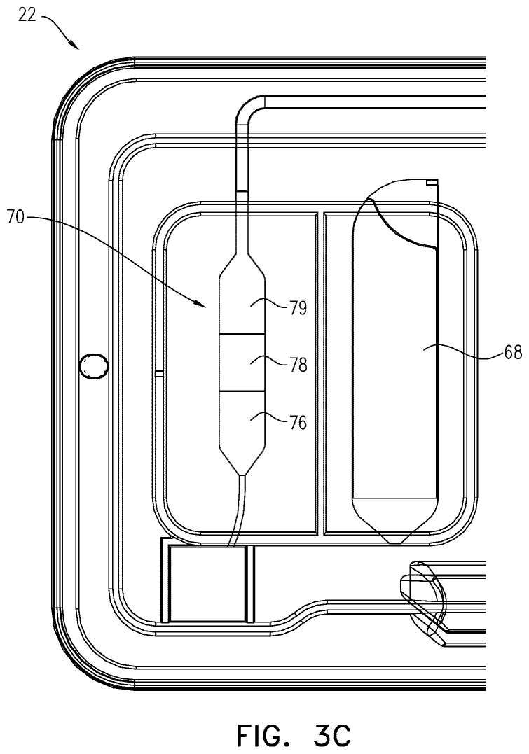

Reference is now made to FIGS. 3A and 3B, which are schematic illustrations of respective views of sample carrier 22, when the sample carrier is fully assembled, in accordance with some applications of the present invention. FIG. 3A shows an oblique view of the sample carrier, and FIG. 3B shows a side view. Typically, the sample carrier includes main body 50, which includes an upper substrate 52 and a lower substrate 54. The upper and lower substrates are typically polymers (e.g., plastics) that are molded (e.g., via injection molding) to provide the sample carrier with desired internal and external geometrical shapes and dimensions. The sample carrier is formed by adhering the upper and lower substrates to each other. For example, the upper and lower substrates may be bonded to each other during manufacture or assembly (e.g., using thermal bonding, solvent-assisted bonding, ultrasonic welding, laser welding, heat staking, adhesive, mechanical clamping and/or additional substrates). Typically, the upper and lower substrates are adhered to each other using an adhesive layer 56, which is typically a pressure-sensitive adhesive. In addition, the sample carrier typically includes a cap 58 which is placed onto the main body of the sample carrier after the sample has been received by the sample carrier. Typically, the cap is configured to become irreversibly coupled to the main body of the sample carrier by being placed onto the main body of the sample carrier, as described in further detail hereinbelow. For some applications, after a sample has been taken, and the cap has been placed upon the main body of the sample carrier, an identification label 60 is placed on the sample carrier, as shown.

Typically, the sample carrier defines a plurality of ports, for example, a first port 62, a second port 64, and a third port 66, functions of which are described in further detail hereinbelow. Further typically, the sample carrier includes one or more analysis chambers, for example, a microscope analysis chamber 68, and an optical-density analysis chamber 70. For some applications, the analysis chambers are recessed with respect to an outer surface 72 of the sample carrier. For some such applications, one or more protective ribs 74 are disposed between the analysis chambers, in order to prevent a user from touching outer surfaces of the analysis chambers.

For some applications, a sample carrier as shown in FIGS. 3A-B is used when analyzing a bodily sample. For some applications, the sample is a blood sample that includes blood or components thereof (e.g., a diluted or non-diluted whole blood sample, a sample including predominantly red blood cells, or a diluted sample including predominantly red blood cells), and parameters are determined relating to components in the blood such as platelets, white blood cells, anomalous white blood cells, circulating tumor cells, red blood cells, reticulocytes, Howell-Jolly bodies, sickle cells, teardrop cells, etc. For some applications, the sample is a blood sample, and the sample is analyzed such as to perform a complete blood count. For some applications, the sample includes a fine needle aspirate. For some such applications, parameters are determined relating to components in the sample such as: macrophages, histiocytes, mast cells, plasma cells, melanocytes, epithelial cells, mesenchymal cells, mesothelial cells, bacteria, yeast, and/or parasites. It is noted that the sample may be a human bodily sample or an animal bodily sample.

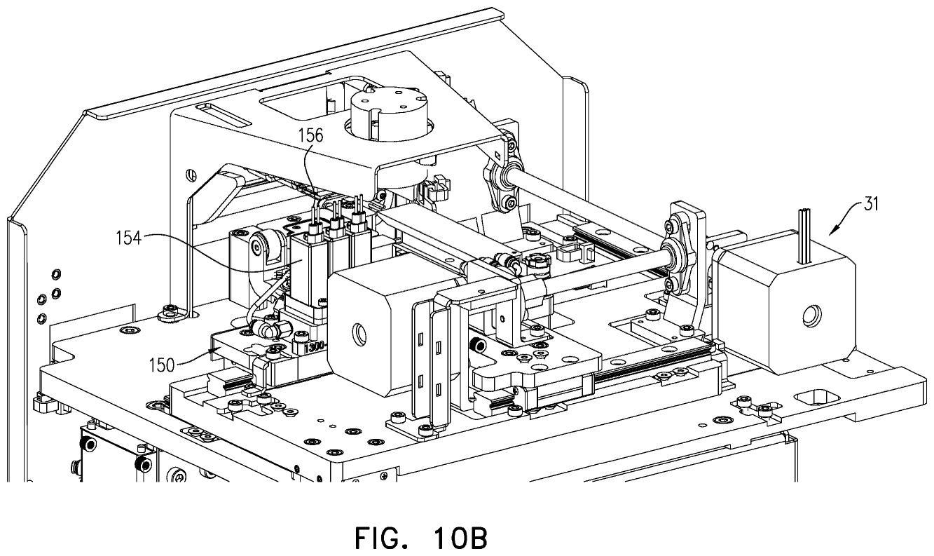

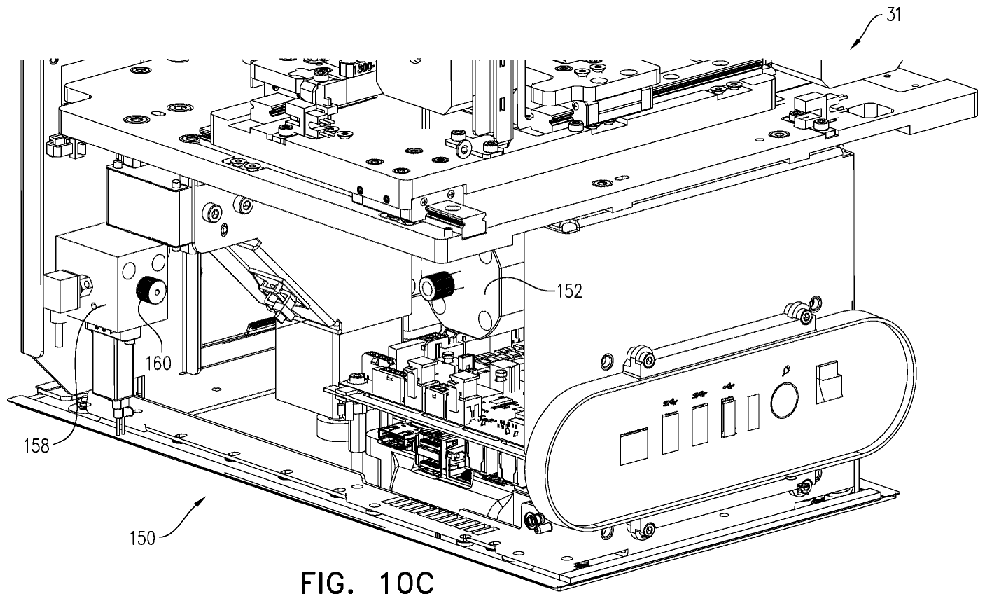

For some such applications, the sample carrier is used with optical measurement unit 31 configured as generally shown and described with reference to FIGS. 2A-B. As described in further detail hereinbelow, for some applications, the optical measurement unit includes a pump system 150 (shown in FIGS. 10A-C) which is configured to pump fluid through fluidic channels defined by the sample carrier. For some applications, a first portion of the sample is pumped into microscope analysis chamber 68 (which is used for performing microscopic analysis upon the sample, e.g., using microscope system 37 (shown in FIG. 2B)), and a second portion of the sample is pumped into optical-density analysis chamber 70 (which is used for performing optical density measurements upon the sample, e.g., using optical-density-measurement device 48 (shown in FIG. 2B)).

It is noted that for some applications (not shown), the sample carrier includes a plurality of microscope analysis chambers 68 and/or a plurality of optical-density analysis chambers 70. It is further noted that, although the sample carrier as shown in the figures includes both microscope analysis chamber 68 and optical-density analysis chamber 70, the scope of the present disclosure includes a sample carrier that includes only one type of analysis chamber (i.e., either microscope analysis chamber 68 or optical-density analysis chamber 70) and the components and methods associated with that type of analysis chamber, mutatis mutandis.

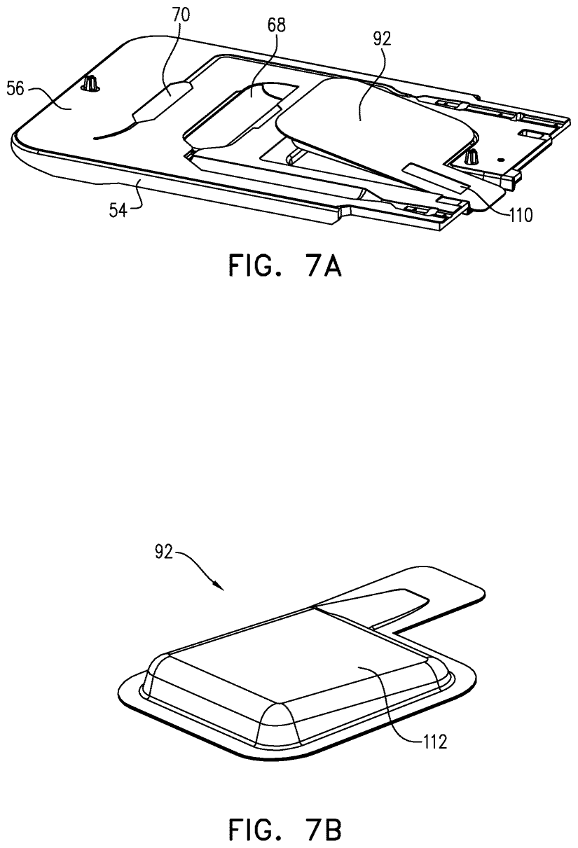

The first portion of the sample (which is pumped into microscope analysis chamber 68 and upon which the microscopic analysis is performed) is typically diluted with respect to the second portion of the sample. For example, the diluent may contain pH buffers, stains, fluorescent stains, antibodies, sphering agents, lysing agents, etc. For some applications, the diluent is housed within a receptacle (e.g., a blister pack 92, shown in FIG. 7A), which is housed within the sample carrier, as described in further detail hereinbelow. Typically, the second portion of the sample, (which is pumped into optical-density analysis chamber 70 and upon which the optical-density measurements are performed) is a natural, undiluted sample. Alternatively or additionally, the second portion of the sample is a sample that underwent some modification, including, for example, one or more of dilution (e.g., dilution in a controlled fashion), addition of a component or reagent (e.g., hemolysin), and/or fractionation.

For some applications, one or more stains are used to stain the first portion of the bodily sample (which is pumped into microscope analysis chamber 68) before the first portion of the sample is imaged microscopically. For example, the stain may be configured to stain DNA with preference over staining of other cellular components. Alternatively, the stain may be configured to stain all cellular nucleic acids with preference over staining of other cellular components. For example, the sample may be stained with Acridine Orange reagent, a blue-fluorescent bis-benzimide dye (e.g., a Hoechst reagent), and/or any other stain that is configured to preferentially stain DNA and/or RNA within the bodily sample. Optionally, the stain is configured to stain all cellular nucleic acids but the staining of DNA and RNA are each more prominently visible under some lighting and filter conditions, as is known, for example, for Acridine Orange. Images of the sample may be acquired using imaging conditions that allow detection of cells (e.g., brightfield) and/or imaging conditions that allow visualization of stained bodies (e.g., appropriate fluorescent illumination). Typically, the first portion of the sample is stained with Acridine Orange and with a blue-fluorescent bis-benzimide dye (e.g., a Hoechst reagent). For some applications, the sample is a blood sample, and the first portion of the sample is stained with one or more stains that cause platelets within the blood sample to be visible under brightfield imaging conditions and/or under fluorescent imaging conditions, e.g., as described hereinabove. For example, the first portion of the sample may be stained with methylene blue and/or Romanowsky stains. For some applications, the sample is a fine needle aspirate sample, and the first portion of the sample is stained with stains that cause one or more of the following entities to fluoresce: macrophages, histiocytes, mast cells, plasma cells, melanocytes, epithelial cells, mesenchymal cells, mesothelial cells, bacteria, yeast, and/or parasites.

Reference is now made to FIG. 3C, which is a schematic illustration of microscope analysis chamber 68 and optical-density analysis chamber 70 of the sample carrier, in accordance with some applications of the present invention. Typically, prior to being imaged microscopically (and subsequent to being pumped into microscope analysis chamber 68), the first portion of the sample is allowed to settle such as to form a monolayer of cells, e.g., using techniques as described in U.S. Pat. No. 9,329,129 to Pollak, which is incorporated herein by reference. For some applications, the first portion of the sample is a cell suspension and the microscope analysis chamber 68 defines a closed cavity that includes a base surface and a closed top. Typically, the cells in the cell suspension are allowed to settle on the base surface of the microscope analysis chamber to form a monolayer of cells on the base surface of the microscope analysis chamber. Subsequent to the cells having been left to settle on the base surface of the microscope analysis chamber (e.g., by having been left to settle for a predefined time interval), at least one microscopic image of at least a portion of the monolayer of cells is typically acquired. Typically, a plurality of images of the monolayer are acquired, each of the images corresponding to an imaging field that is located at a respective, different area within the imaging plane of the monolayer. Typically, an optimum depth level at which to focus the microscope in order to image the monolayer is determined, e.g., using techniques as described in U.S. Pat. No. 10,176,565 to Greenfield, which is incorporated herein by reference. For some applications, respective imaging fields have different optimum depth levels from each other. It is noted that, in the context of the present application, the term monolayer is used to mean a layer of cells that have settled, such as to be disposed within a single focus level of the microscope (referred to herein as “the monolayer focus level”). Within the monolayer there may be some overlap of cells, such that within certain areas there are two or more overlapping layers of cells. For example, within a blood sample, red blood cells may overlap with each other within the monolayer, and/or platelets may overlap with, or be disposed above, red blood cells within the monolayer.

For some applications, subsequent to being pumped into microscope analysis chamber 68 and prior to being imaged microscopically, the first portion of the sample is allowed to settle for a sufficiently long time period for (a) the cells to settle into a monolayer, and (b) for stains to penetrate the cells within the monolayer.

For some applications, the microscopic analysis of the first portion of the sample is performed with respect to the monolayer of cells. Typically, the first portion of the sample is imaged under brightfield imaging, i.e., under illumination from one or more light sources (e.g., one or more light emitting diodes, which typically emit light at respective spectral bands). Further typically, the first portion of the sample is additionally imaged under fluorescent imaging. Typically, the fluorescent imaging is performed by exciting stained objects (i.e., objects that have absorbed the stain(s)) within the sample, by directing light toward the sample at known excitation wavelengths (i.e., wavelengths at which it is known that stained objects emit fluorescent light if excited with light at those wavelengths), and detecting the fluorescent light. Typically, for the fluorescent imaging, a separate set of light sources (e.g., one or more light emitting diodes) is used to illuminate the sample at the known excitation wavelengths. As described hereinabove, for some applications, the sample is stained with Acridine Orange reagent and a blue-fluorescent bis-benzimide dye (e.g., a Hoechst reagent). For some such applications, the sample is illuminated with light that is at least partially within the UV range (e.g., 300-400 nm), and/or with light that is at least partially within the blue light range (e.g., 450-520 nm), in order to excite the stained objects.

Referring again to FIG. 2B, typically, sample carrier 22 is supported within the optical measurement unit by stage 42. For some applications, the stage has a forked design, such that the sample carrier is supported by the stage around the edges of the sample carrier, but such that the stage does not interfere with the visibility of the sample chambers of the sample carrier by the optical measurement devices. Typically, at least some light sources 44 that are used during microscopic measurements that are performed upon the sample (for example, light sources that are used during brightfield imaging) illuminate the sample carrier from above the sample carrier. Further typically, at least some additional light sources (not shown) illuminate the sample carrier from below the sample carrier (e.g., via the objective lens). For example, light sources that are used to excite the sample during fluorescent microscopy may illuminate the sample carrier from below the sample carrier (e.g., via the objective lens).

Typically, an optical density measurement is performed on the second portion of the sample (which is typically pumped into optical-density analysis chamber 70 in an undiluted form). For example, the concentration and/or density of a component may be measured by performing optical absorption, transmittance, fluorescence, and/or luminescence measurements upon the sample. Typically, in order to perform optical density measurements upon the sample, it is desirable to know the optical path length, the volume, and/or the thickness of the portion of the sample upon which the optical measurements were performed, as precisely as possible. Typically, the optical path length is defined by the height of the optical-density analysis chamber, with the upper surface of the optical-density analysis chamber being defined by the upper substrate and the lower surface of the optical-density analysis chamber being defined by the lower substrate. As described with reference to FIGS. 3A-B, typically, the upper and lower substrates are adhered to each other using an adhesive layer 56, which is typically a pressure-sensitive adhesive. In some cases, due to tolerances in the manufacturing process, this results in the absolute height of the optical-density analysis chamber not being known to a sufficient degree of accuracy to analyze the optical-density measurements that are performed on the second portion of the sample.

For some applications, optical-density analysis chamber 70 defines at least a first region 76 (which is typically shallower) and a second region 78 (which is typically higher), the height of the optical-density analysis chamber varying between the first and second regions in a predefined manner, e.g., in a generally similar manner to that described in U.S. Pat. No. 11,307,196 to Pollak, which is incorporated herein by reference. The heights of first region 76 and second region 78 of the optical-density analysis chamber are defined by a lower surface that is defined by the lower substrate and by an upper surface that is defined by the upper substrate. The surface of either the upper or the lower substrate at the second region is stepped with respect to the surface of the same substrate at the first region. The step between the upper surface at the first and second regions, provides a predefined height difference between the regions, such that even if the absolute height of the regions is not known to a sufficient degree of accuracy (for example, due to tolerances in the manufacturing process, as described above), the height difference is known to a sufficient degree of accuracy to determine a parameter of the sample, using the techniques described herein, and as described in U.S. Pat. No. 11,307,196 to Pollak, which is incorporated herein by reference. For some applications, the height of optical-density analysis chamber 70 varies from the first region 76 to the second region 78, and the height then varies again from the second region to a third region 79, such that, along the optical-density analysis chamber, first region 76 defines a minimum height region, second region 78 defines a medium height region, and third region 79 defines a maximum height region. For some applications, additional variations in height occur along the length of the optical-density analysis chamber, and/or the height varies gradually along the length of the optical-density analysis chamber.

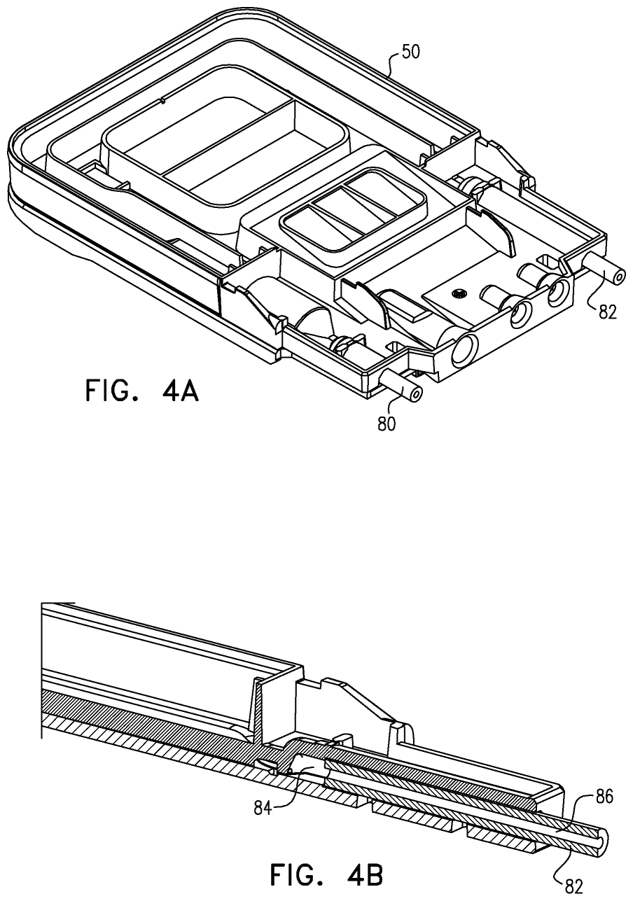

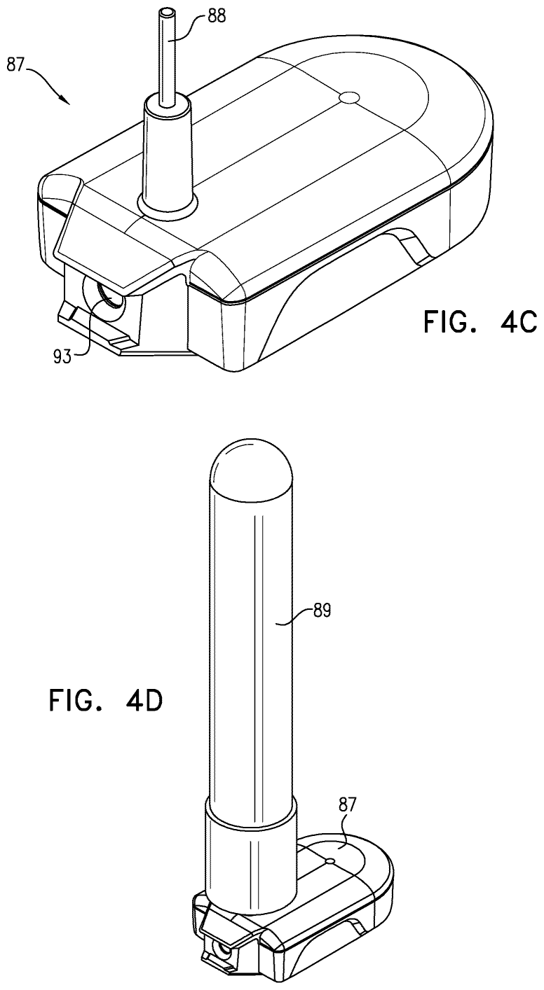

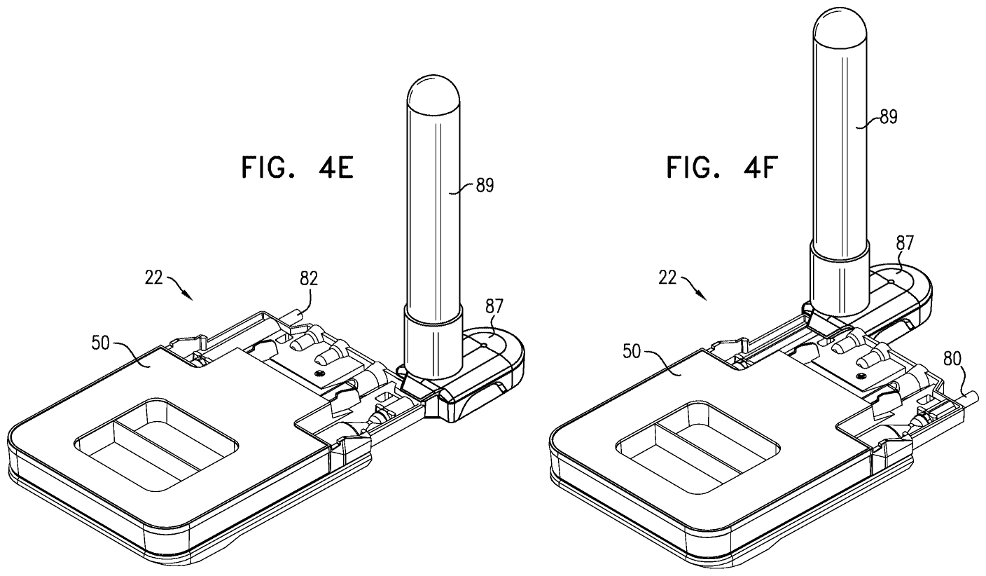

Reference is now made to FIGS. 4A and 4B, which are schematic illustrations of portions of the sample carrier 22 prior to cap 58 being applied to main body 50 of the sample carrier, in accordance with some applications of the present invention. FIG. 4A shows an oblique view of the main body of the sample carrier. As shown, typically, a first capillary tube 80 and a second capillary tube 82 protrude from the main body of the sample carrier. The user typically places the bodily sample into the sample carrier via the capillary tubes. For example, when used to analyze a blood sample, ends of each of the capillary tubes may be placed directly into blood, e.g., venous blood, or blood from a finger prick. For some applications, blood is taken from an ear prick. For example, when used for analysis of animal blood, the blood may be drawn from an ear prick. Alternatively, an applicator or an adaptor (e.g., as shown in FIGS. 4C-F) is used to place blood in contact with the ends of the capillary tubes. Typically, the blood from capillary tube 80 is mixed with a diluent and is pumped into analysis chamber 68, while blood from capillary tube 82 is pumped (undiluted) into analysis chamber 70. For some applications, the sample is a fine needle aspirate. For some applications, the sample is injected into the capillary tubes, or is injected into a different portion of the sample carrier (e.g., directly into a blister pack 92 (described hereinbelow) or a portion of a fluidic channel (e.g., a mixing chamber 126, described hereinbelow) of the sample carrier). It is noted that although some applications of the present disclosure are described with reference to a sample carrier that includes first and second capillary tubes, the scope of the present disclosure includes a sample carrier that includes only a single capillary tube or no capillary tubes. For example, the system may be configured such as to separate first and second portions of a sample from a single capillary tube. Alternatively or additionally, the sample may be placed within the sample carrier in a different manner, such as by being injected into a different portion of the sample carrier (e.g., directly into a blister pack 92 (described hereinbelow) or a portion of a fluidic channel (e.g., a mixing chamber 126, described hereinbelow) of the sample carrier).

FIG. 4B shows a cross-sectional view of capillary tube 82. As shown, for some applications, the end of the capillary tube that is within the sample carrier is disposed adjacent to a relatively wide cavity 84, which acts as a capillary break and prevents the sample from flowing further in the absence of pressure being applied to the sample. Thus, in the absence of positive pressure being used to pump the sample out of the capillary tube and into the fluidic channels within the sample carrier, the sample typically fills up lumen 86 of the capillary tube and remains stored within the lumen. Although capillary tube 82 is shown in FIG. 4B, typically capillary tube 80 is configured in a generally similar manner.

Reference is now made to FIGS. 4C, 4D, 4E, and 4F, which are schematic illustrations of an adaptor 87 for placing a bodily sample in fluid communication with a capillary tube (e.g., capillary tube 80 and/or capillary tube 82) of sample carrier 22, in accordance with some applications of the present invention. For some applications, a bodily sample (such as a blood sample) is dispensed from a sample tube 89 (e.g., a vacutainer®) to the sample carrier. Performing blood tests on venous blood samples typically requires extracting low volumes of blood from sample tube 89 and collecting them into the sample carrier. For some applications, the sample is transferred from the sample tube to capillary tubes 80 and 82, such that it gets collected by the capillary tubes when a drop forms without the drop contacting any external surface, thereby eliminating a user step and reducing biohazard risk. Typically, the sample tube is placed onto a needle 88 of the adaptor, such that a portion of the sample flows through the needle. The adaptor is then coupled to the sample carrier, such that the portion of the sample is placed in fluid communication with either capillary tube 80 (as shown in FIG. 4E) or capillary tube 82 (as shown in FIG. 4F), via an opening 93. Typically, opening 93 is self-sealing. Typically, the adaptor is coupled to main body 50 of the sample carrier prior to the cap being applied to the main body of the sample carrier. The adaptor is typically removed from the main body of the sample carrier before the cap is applied to the main body of the sample carrier.

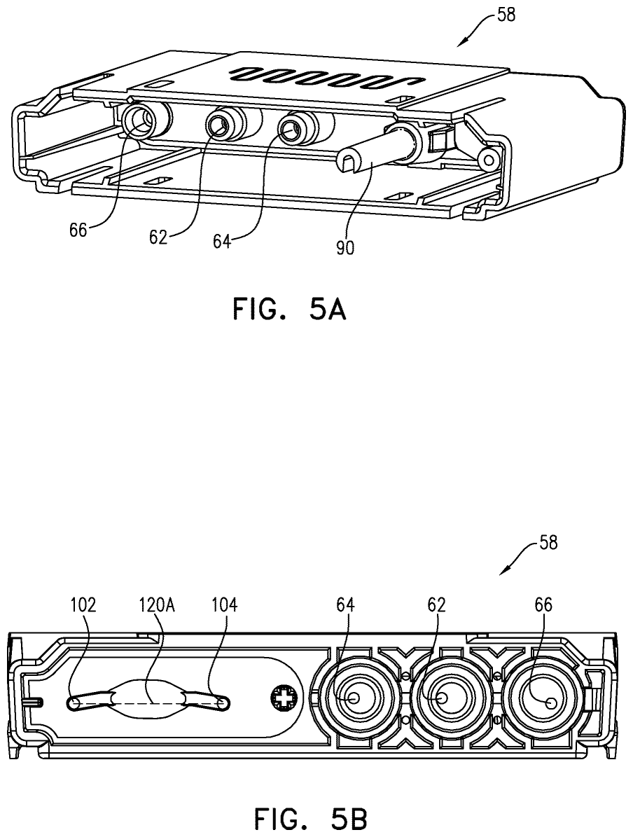

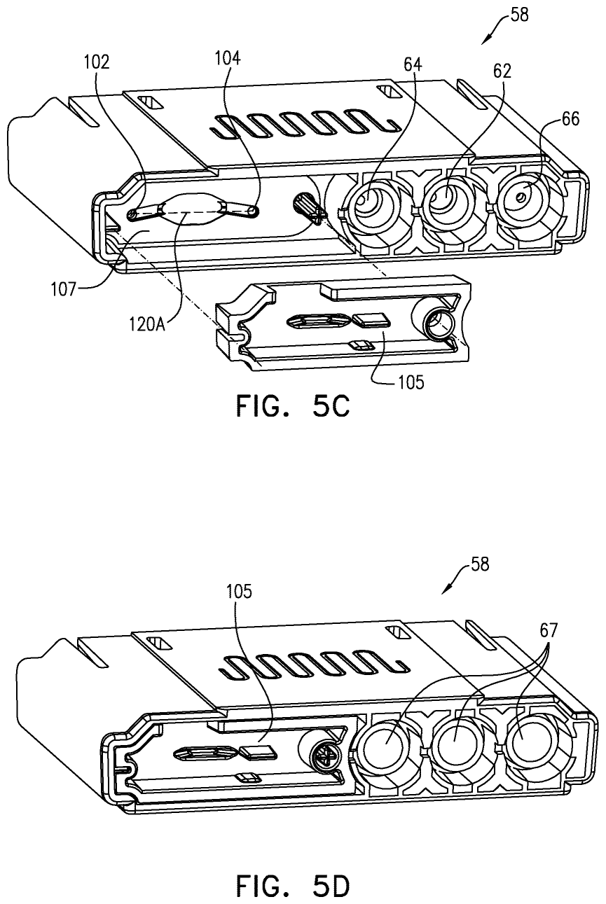

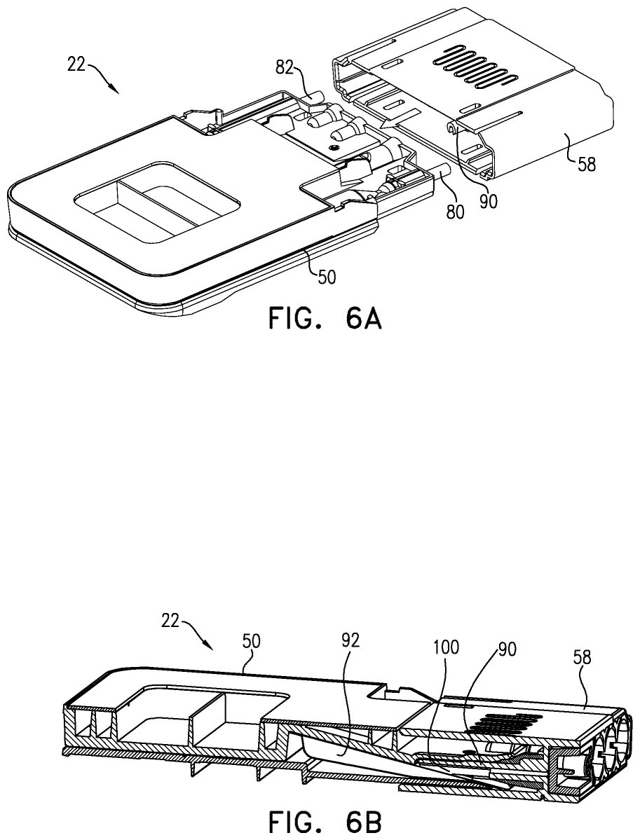

Reference is now made to FIGS. 5A, 5B, 5C and 5D, which are schematic illustrations of cap 58 of sample carrier 22, in accordance with some applications of the present invention. (FIG. 5A shows an oblique view in which the inside of the cap is visible, FIG. 5B shows an end-view of the outside of the cap (in the absence of a cover plate 105 (shown in FIGS. 5C and 5D) having been placed over the cap), FIGS. 5C and 5D show oblique views of the cap in which the outside of the cap is visible, with FIG. 5D showing a membrane 67 and with FIG. 5C (and FIG. 5B) showing the cap in the absence of the membrane.) Reference is also made to FIGS. 6A and 6B, which are schematic illustrations of the cap being placed on main body 50 of the sample carrier, in accordance with some applications of the present invention. Typically, the user places the cap onto the main body of the sample carrier after the sample has been placed into the capillary tubes. Further typically, placement of the cap onto the main body of the sample carrier seals the sample within the main body of the sample carrier. For some applications, the cap is configured such that upon being placed onto the main body of the sample carrier, the cap becomes irreversibly coupled to the sample carrier, such that the bodily sample becomes irreversibly sealed within the sample carrier, thereby preventing contamination of the sample carrier.

It is noted that the “irreversible coupling” of the cap to the sample carrier should not be interpreted as meaning that it is impossible to force the cap from the sample carrier. Rather, that when used in a normal manner the cap is not readily detachable from the sample carrier, such that any abnormal tampering with the sample carrier in order to detach the cap from the main body of the sample carrier would be readily detectable. As shown in FIG. 3A, for some applications identification label 60 is configured to be placed on the sample carrier such that it covers both the main body and the cap of the sample carrier. Thus, any tampering with the sample carrier in order to decouple the cap from the main body of the sample carrier is typically detectable because the label is likely to be torn.

Typically, once the cap has been placed on the main body of the sample carrier, the bodily sample is sealed within the sample carrier, but the bodily sample has not yet been pumped to the analysis chambers (since this typically occurs only after the sample carrier has been inserted into the optical measurement unit). For some applications, this enables the sample carrier to be safely transported over a small distance, e.g., from a first room in which the sample is taken to a nearby room in which the optical measurement unit is located.

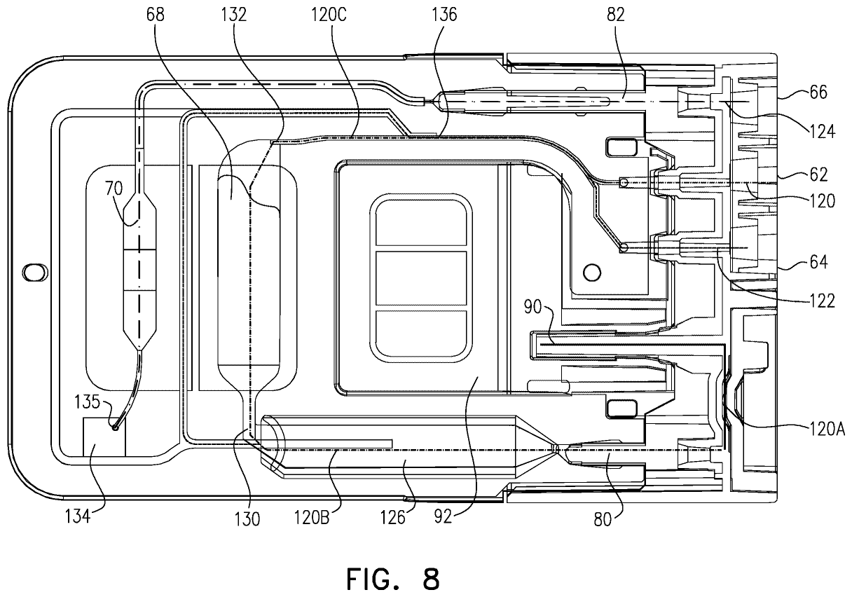

As shown in FIGS. 5A-D, the cap defines first port 62, second port 64, and third port 66 of the sample carrier. (For some applications, membrane 67 is disposed within the ports, the membrane being describe in further detail hereinbelow. As noted above, FIGS. 5B and 5C show the cap in the absence of the membrane for illustrative purposes, while FIG. 5D shows a similar view of the cap to that shown in FIG. 5C, but with the membrane being shown.) Typically, within the sample carrier, the first port opens into a first fluidic channel 120 and the second port opens into a second fluidic channel 122, with the first and second fluidic channels being shown and described in further detail with reference to FIG. 8. For some applications, the third port leads to capillary tube 82. Typically, capillary tube 82 leads into a third fluidic channel 124, which is again shown and described in further detail with reference to FIG. 8. Typically, when the sample carrier is placed within the optical measurement unit, the cap provides an interface between the optical measurement unit and the main body of the sample carrier. As described hereinbelow, for some applications, the optical measurement unit includes a pump system 150 (of one or more pumps, shown in FIGS. 10A-C) that pump the bodily sample through one or more of the fluidic channels of the sample carrier. Typically, the cap acts as the interface between the pump system of the optical measurement unit and the fluidic channels.

As shown in FIG. 5A, for some applications, a puncture needle 90 protrudes from the inner surface of the cap. The puncture needle is configured to puncture a blister pack 92 that is disposed within the main body of the sample carrier, as the cap is placed onto the main body of the sample carrier. FIG. 6B shows the puncture needle having punctured the blister pack. For some applications, the blister pack comprises a receptacle that houses the diluent that is used to dilute the first portion of the bodily sample (which is pumped to microscope analysis chamber 68). Typically, the puncture needle is configured to puncture the blister pack and to the thereby place the diluent that is housed within the blister into fluid communication with a fluidic channel 120A that is defined by the cap. The puncture needle is typically hollow along its length, such that it defines a hole 104 at the end of the puncture needle that is remote from the blister pack. Fluidic channel 120A extends through the puncture needle and from hole 104 to a hole 102, which is in fluid communication with capillary tube 80. Fluidic channel 120A is typically sealed via cover plate 105 being placed over holes 102 and 104, as shown in the transition from FIG. 5C to 5D. The puncturing of the blister pack by the puncture needle typically places the diluent into fluid communication with the first portion of the bodily sample, via fluidic channel 120A, which extends through the cap. Thus, placing the cap on the main body of the sample carrier not only punctures the blister pack, but also places the diluent into fluid communication with the first portion of the bodily sample. As discussed in further detail hereinbelow, pump system 150 (shown in FIGS. 10A-C, and which is typically housed within optical-measurement unit 31) typically pumps the first portion of the bodily sample and the diluent back-and-forth along fluidic channel 120 (a portion of which is fluidic channel 120A) in order to mix the bodily sample with the diluent, prior to pumping the mixture of the bodily sample and the diluent into microscope analysis chamber 68. As described hereinabove, for some applications, the first portion of the bodily sample is stained with stains.

For some applications, the stains are housed within the cap in a dry form and positioned such that it is difficult for a user to tamper with the stains. For example, the stains may be housed along fluidic channel 120A. The cap is configured such that as the diluent flows out of the blister pack, the diluent mixes with the stain and the diluent and the stain then mix with the bodily sample. Thus, placing the cap on the main body of the sample carrier not only punctures the blister pack, and places the diluent into fluid communication with the first portion of the bodily sample, but also causes the stain to mix with the diluent and the first portion of the bodily sample. For some applications, during manufacture of the sample carrier, the stain is placed along fluidic channel 120A before cover plate 105 is placed over holes 102 and 104. Cover plate 105 is then placed over holes 102 and 104 and coupled to the cap, such that the stain cannot be tampered with without causing irreversible (and typically visible and/or detectable) damage to the cap.

For some applications, the portion of the puncture needle that punctures the blister pack has an upside-down U-shaped cross-section, such that an open portion 100 of the U forms a portion of fluidic channel 120A, which extends from the blister pack once the blister pack has been punctured. Thus, a continuous fluidic channel is formed that extends from the blister back, through the puncture needle, and into the main body of the sample carrier (via capillary tube 80).

Typically, ports 62, 64, and 66, prevent air from being forced into fluidic channels of the sample carrier as the cap is placed on the main body of the sample carrier. Port 66, which is placed over capillary tube 82, prevents the bodily sample from being pushed along the capillary tube as the cap is placed on the main body of the sample carrier. For some applications, a membrane 67 (e.g., a hydrophobic membrane, such as a PTFE membrane, shown in FIG. 5D) is disposed within ports 62, 64, and 66 and is configured to prevent capillary action from filling the ports with the bodily sample. Subsequently, when the pump system pumps fluid (e.g., air) through the ports, the fluid flows through membrane and pumps any of the bodily sample that is stuck on the membrane into the corresponding fluidic channel or capillary tube of the sample carrier. For some applications, a membrane 107 (e.g., a hydrophobic membrane, such as a PTFE membrane, shown in FIG. 5C) is disposed around fluidic channel 120A, such as to prevent blood and/or diluent from flowing out of the fluidic channel.

Reference is now made to FIGS. 7A and 7B are schematic illustrations of blister pack 92 of sample carrier 22, in accordance with some applications of the present invention. FIG. 7A shows the blister pack within the sample carrier with some portions of the sample carrier (e.g., upper substrate 52 and cap 58) hidden, in order to illustrate the orientation of the blister pack within the sample carrier. FIG. 7B shows a bottom view of the blister pack, in which an underside 112 of the blister may be seen. As described hereinabove, typically the blister pack is punctured by puncture needle 90 (shown in FIG. 5A). For some applications, the puncture needle is configured to puncture the blister pack at a puncture region 110, shown in FIG. 7A.

As described hereinabove, sample carrier is typically supported within optical measurement unit 31 by stage 42. Typically, the stage is configured to hold the sample carrier such that a base surface microscope analysis chamber 68 and/or a base surface of optical-density measurement chamber 70 is disposed in a horizontal orientation. As shown in FIG. 7A, for some applications, the blister pack is disposed within the sample carrier at an angle (i.e., at a non-zero angle) to the base surface of the analysis chambers. Typically, in this manner, the blister pack acts as a bubble trap whereby any air that enters fluidic channels that are in fluid communication with the blister pack flows to the upper end of the blister pack, which is disposed remotely from puncture region 110. It is noted that although FIGS. 7A-B show a blister pack being used as the receptacle for housing the diluent the scope of the present disclosure includes applying the apparatus and methods described herein to any suitable receptacle.

Reference is now made to FIG. 8, which is a schematic illustration of fluidic channels through the sample carrier, in accordance with some applications of the present invention. As described hereinabove, once the sample carrier has been assembled (i.e., the cap has been applied to the main body), the sample carrier typically defines a first fluidic channel 120 extending to port 62, a second fluidic channel 122 extending to port 64, and a third fluidic channel 124 extending to port 66 via capillary tube 82. Typically, fluidic channel 120 extends from blister pack 92 to port 62 and comprises three portions: fluidic channel 120A (which is defined by cap 58 and extends from the blister pack to capillary tube 80), fluidic channel 120B (which extends from the end of capillary tube 80 to an inlet 130 of the microscope analysis chamber), and fluidic channel 120C (which extends from an outlet 132 of the microscope analysis chamber to port 62). (Fluidic channels 120A, 120B and 120C are referred to herein both as fluidic channels and as portions of fluidic channel 120.) For some applications, second fluidic channel 122 extends from port 64 to inlet 130 of microscope analysis chamber 68, at which point second fluidic channel 122 merges with fluidic channel 120B.

Typically, pump system 150 (shown in FIGS. 10A-C) applies pressure to fluidic channel 120 (via port 62) and/or to fluidic channel 122 (via port 64) in order to (a) pump the first portion of the sample into the fluidic channel 120 from capillary tube 80 and (b) to pump the diluent from the blister pack into fluidic channel 120 (via fluidic channel 120A). In this manner, the first portion of the sample and the diluent are mixed with each other. As noted hereinabove, for some applications, the diluent is mixed with one or more stains, which are disposed within a portion of cap 58 (e.g., within the fluidic channel 120A). Typically, when the bodily sample is initially pumped from capillary tube 80, it is pumped relatively slowly, in order to reduce a likelihood of air entering fluidic channel 120.

Fluidic channel 120 is typically a continuous fluidic channel extending from the blister pack to port 62. Typically, portions 120A and 120B of the fluidic channel extend from the blister pack to an inlet 130 of the microscope analysis chamber, and portion 120C extends from an outlet 132 of the microscope analysis chamber to port 62. Typically, portions 120A and 120B of the continuous fluidic channel include a plurality of portions having respective cross-sectional areas. For some applications, as the first portion of the sample and the diluent are pumped between the portions of the fluidic channel the bodily sample and the diluent are mixed with each other. For example, fluidic channel 120 may include a mixing chamber 126, which has a greater cross-sectional area than a portion of the fluidic channel adjacent to it. Typically, the fluid flow dynamics that arise from the bodily sample and the diluent being pumped into a portion of the fluidic channel having a greater cross-sectional area than a portion adjacent to it (such as the mixing chamber) encourage mixing of the bodily sample and the diluent. For example, as the bodily sample and the diluent are pumped into a portion of the fluidic channel in which the cross-sectional area of the channel sharply increases, this can give rise to turbulence, jets, Eddy currents, etc., which can encourage mixing of the bodily sample and the diluent.

For some applications, the pump system pumps the first portion of the sample and the diluent in forward and reverse fluid flow directions along portions 120A and 120B of fluidic channel 120 (e.g., by pumping via port 62 and/or 64 in a first direction and then in the opposite direction) in order to mix the sample and the diluent. Typically, when the first portion of the sample and the diluent are pumped in the reverse direction, some of the sample and the diluent are pumped back into blister pack 92 (or another diluent receptacle), such that the diluent and the bodily sample are mixed within the blister pack (or the other diluent receptacle). Thus, the blister pack (or the other receptacle) is initially used to store the diluent (typically in a sealed manner), and is subsequently used as a mixing chamber for mixing of the diluent and the sample. It is noted that using the blister pack (or the other receptacle that is initially used for storing the diluent) as a mixing chamber may reduce the volume of the sample carrier, relative to a similar sample carrier that utilizes a separate mixing chamber (in addition to mixing chamber 126) to perform this function of the blister pack. It is noted that, typically, the cross-sectional area of the blister pack (or the other receptacle) is greater than that of fluidic channel 120A. Therefore, the above-described effect of the bodily sample and the diluent being mixed by being pumped into a portion of the fluidic channel having a greater cross-sectional area than a portion adjacent to it, typically occurs as the bodily sample and the diluent are pumped into the blister pack (or the other receptacle). As noted above, for some applications, the blister pack is additionally configured to act as a bubble trap by virtue of its orientation within the sample carrier. It is noted that using the blister pack (or the other receptacle that is initially used for storing the diluent) as a bubble trap may reduce the volume of the sample carrier, relative to a similar sample carrier that utilizes a separate portion to perform this function of the blister pack.

As noted above, for some applications, the pump system pumps the bodily sample and the diluent in forward and reverse fluid flow directions along portions 120A and 120B of the fluidic channel 120 (e.g., by pumping via port 62 and/or 64 in a first direction and then in the opposite direction) in order to mix the bodily sample and the diluent. For some applications, pump system 150 (shown in FIGS. 10A-C) comprises at least one pump that is a volumetric pump (i.e., it is configured to pump defined volumes of fluid into the sample carrier). For some applications, the volumetric pump is initially configured to pump a first predetermined volume of fluid (e.g., air) into and out of portions 120A and 120B of the fluidic channel 120 to thereby mix the bodily sample and the diluent. At this stage (i.e., prior to the bodily sample and the diluent (and, optionally, stain(s)) being sufficiently mixed), the pump is configured not to pump any of the bodily sample or the diluent into the microscope analysis chamber. Subsequently (and typically once the bodily sample and the diluent (and, optionally, stain(s)) have been sufficiently mixed), the pump pumps a second predetermined volume of fluid out of portion 120B of fluidic channel 120 to fill the microscope analysis chamber with a mixture of the diluent and the bodily sample.

In some cases, after the mixture of the bodily sample and the diluent have been pumped into the microscope analysis chamber, the blister pack can undergo changes in shape which can cause movement of the sample within the microscope analysis chamber by imparting pressure changes to the microscope analysis chamber. For example, the blister pack can expand, which could impart vacuum pressure to the microscope analysis chamber thereby drawing the sample from inlet 130 of the microscope analysis chamber. Or, the blister pack can contract, which could impart positive pressure to the microscope analysis chamber thereby pumping the sample out of outlet 132 of the microscope analysis chamber. For some applications, pump system 150 (shown in FIGS. 10A-C) is configured to maintain the mixture of the bodily sample and the diluent in a settled stated within the analysis chamber by balancing pressure between the inlet and outlet of the microscope analysis chamber. Typically, the pump system achieves this by controlling pressure at inlet 130 of the microscope analysis chamber via second port 64 and second fluidic channel 122 (which extends from the second port to the inlet). For some applications, equal amounts of pressure are applied via the first port and via the second port, such that equal amounts of pressure are applied via the first and second fluidic channels.

For some applications, subsequent to pumping the mixture of the bodily sample and the diluent into microscope analysis chamber 68, pump system 150 (shown in FIGS. 10A-C) balances pressure between inlet 130 and outlet 132 of the microscope analysis chamber by exposing both first port 62 and second port 64 to atmospheric pressure. In this manner, both inlet 130 and outlet 132 of the microscope analysis chamber are exposed to atmospheric pressure, and the mixture within the microscope analysis chamber remains in a settled state even if the blister pack undergoes shape changes. It is noted that the scope of the present disclosure includes utilizing the aforementioned method and apparatus for maintaining a sample in a settled stated within an analysis chamber in any configuration of sample carrier and not necessarily the configuration of sample carrier described herein.

For some applications, subsequent to pumping the mixture of the bodily sample and the diluent into microscope analysis chamber 68, pump system 150 (shown in FIGS. 10A-C) balances pressure between inlet 130 and outlet 132 of the microscope analysis chamber by pumping a predetermined volume of fluid via second port 64 and second fluidic channel 122 such as to counteract the pressure that is applied to the mixture in the analysis chamber via the first portion of first fluidic channel 120. For example, the changes in volume that the blister pack is likely to undergo may be predetermined and the pump system may pump a corresponding predetermined volume of fluid via second port 64 and second fluidic channel 122 such as to balance the volume change of the blister pack.

Typically, fluidic channel 124 extends from port 66 through second capillary tube 82, and to optical-density analysis chamber 70. Further typically, pump system 150 (shown in FIGS. 10A-C) is configured to pump the bodily sample from the second capillary tube to the optical-density analysis chamber. For some applications, when the bodily sample is initially pumped from capillary tube 82, it is pumped relatively slowly, in order to reduce a likelihood of air entering fluidic channel 124. For some applications, a hydrophobic membrane 134 (e.g., a PTFE membrane) is placed at an outlet 135 of the optical density analysis chamber. The hydrophobic membrane allows air to vent out of the optical-density analysis chamber, but does not allow any of the bodily sample to escape from the sample carrier. For some applications, the presence of the hydrophobic membrane at the outlet allows the optical-density analysis chamber to be filled without the bodily sample flowing out of the sample carrier. Alternatively or additionally, the optical-measurement unit provides feedback to the pump system regarding the extent to which the optical-density analysis chamber is filled, and the pump system controls pumping of the bodily sample into the optical-density analysis chamber in response to the feedback. Further alternatively or additionally, a volumetric pump is used to pump a predetermined amount of the bodily sample to the optical-density analysis chamber to ensure that the optical-density analysis chamber is filled properly (e.g., as described with reference to the microscope analysis chamber). The scope of the present disclosure includes using any one of the above-described apparatus and methods (or any combination thereof) for filling the microscope analysis chamber and/or the optical-density analysis chamber of a sample carrier.

As described hereinabove, the optical-density analysis chamber is typically used for performing optical-density measurements on the second portion of the sample (which is typically undiluted). Such measurements are typically performed in order to determine the concentrations of one or more components within the sample. For example, hemoglobin absorption measurements may be performed in order to determine the concentration of hemoglobin within a blood sample. This being the case it is typically important that a representative portion of the sample is pumped into the optical-density analysis chamber. However, in some cases, as the bodily sample is flowing through fluidic channel 124, some entities within the sample (e.g., red blood cells within a blood sample) have a tendency to stick to walls of the fluidic channel. For example, as blood flows through the fluidic channel with a laminar flow profile, the center of the flow can flow at a greater speed than the flow that is closer to the walls. This can give rise to red blood cells sticking to the walls. Therefore, in accordance with some applications of the present invention, the pump system cyclically pumps the bodily sample in forward and reverse directions from capillary tube 82 to optical-density analysis chamber 70. The cyclical pumping is typically applied such that there is net flow of the bodily sample from the capillary tube to the optical-density analysis chamber. Typically, pumping the bodily sample in forward and reverse directions helps to remove any entities that become stuck the walls of the fluidic channel, while the net flow of the bodily sample from the capillary tube to the optical-density analysis chamber ensures that the optical-density analysis chamber is filled. Alternatively or additionally, as the pump system pumps the bodily sample from capillary tube 82 to optical-density analysis chamber 70, the pump system cyclically varies a speed at which the bodily sample is pumped from the capillary tube 82 to optical-density analysis chamber 70 through fast and slow pumping periods. Typically, pumping the bodily sample more slowly helps to remove any entities that become stuck the walls of the fluidic channel, while pumping the bodily sample more quickly helps to mix the entities within the sample (e.g., by mixing the red blood cells which are removed from the walls back into the sample). For some applications, the pump system pumps air (or a different gas) into the fluidic channel. Typically, the gas-liquid interface between the air (or the other gas) and the bodily sample pulls entities which are stuck to the walls from the walls. The scope of the present disclosure includes using any one of the above-described apparatus and methods (or any combination thereof) for filling the microscope analysis chamber and/or the optical-density analysis chamber of a sample carrier.

As noted above, typically, the sample carrier includes main body 50, which includes upper substrate 52 and lower substrate 54. The upper and lower substrates are typically polymers (e.g., plastics) that are molded (e.g., via injection molding) to provide the sample carrier with desired internal and external geometrical shapes and dimensions. The sample carrier is formed by adhering the upper and lower substrates to each other. For some applications, the substrates are molded such that upon being bonded to each other, there is at least some overlap between a first set of fluidic channels defined by the upper substrate and a second set of fluidic channels defined by the lower substrate. For example, as shown in FIG. 8, there is a region 136 at which first fluidic channel 120 and second fluidic channel 122 are disposed one above the other, such that they overlap with each other.

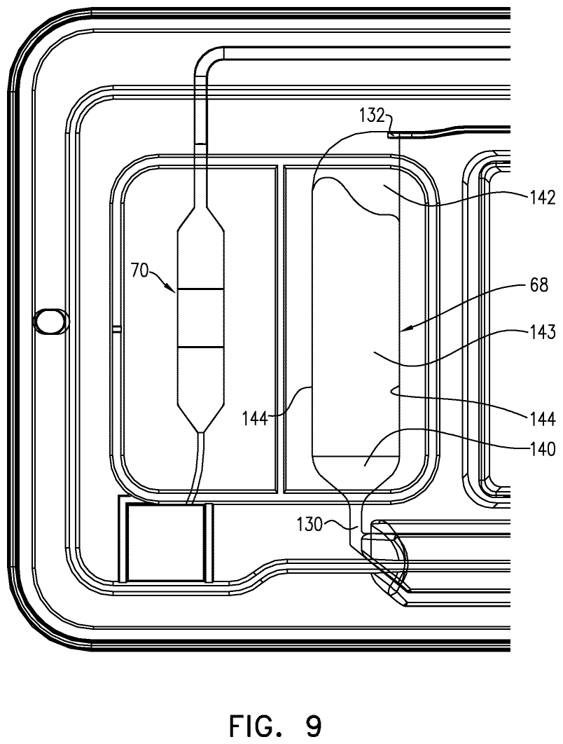

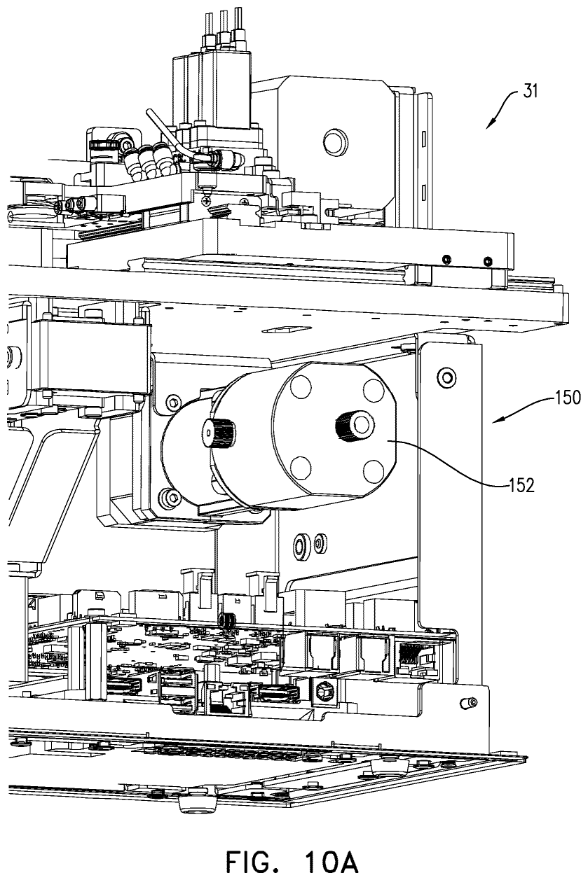

Reference is now made to FIG. 9, which is a schematic illustration of microscope analysis chamber 68 and optical-density analysis chamber 70 of sample carrier 22, in which features of the microscope analysis chamber are shown, in accordance with some applications of the present invention. For some applications, the microscope analysis chamber includes one or more features that are configured to promote uniform filling of the microscope analysis chamber with the mixture of the bodily sample and the diluent and/or are configured to prevent air bubbles from forming within the microscope analysis chamber. For some applications, one or more of these features are also utilized in the optical-density analysis chamber.

For some applications, at an inlet region 140 of the microscope analysis chamber 68 (i.e., a region that is adjacent to inlet 130) the height of the analysis chamber increases in a gradual manner (and uniformly across the width of the chamber), to thereby encourage uniform filling of the analysis chamber. For some applications, at an outlet region 142 of the microscope analysis chamber 68 (i.e., a region that is adjacent to outlet 132), the height of the analysis chamber is less than at a central region 143 of the microscope analysis chamber. Typically, the outlet region thereby has greater fluid resistance than a central portion of the analysis chamber, which causes the outlet region to fill last, thereby allowing the central region of the analysis chamber to fill uniformly before the outlet region fills. Thus, the height of the outlet region relative to the central region encourages uniform filling of the central region analysis chamber. (Typically, the microscopic analysis is performed upon the central region of the microscope analysis chamber.) For some applications, the sample carrier defines one or more raised gutters 144 along the analysis chamber that have higher fluidic resistance than the central region of the analysis chamber. Typically, the raised gutters are configured to encourage uniform filling of the central region of the analysis chamber by the bodily sample by maintaining an open air path along the analysis chamber as the central region of the analysis chamber fills.

For some applications, a ratio between the height of central region 143 of the microscope analysis chamber and a height of outlet region 142 is between 3:2 and 5:2. For some applications, the height of the central region of the microscope analysis chamber is 175-225 microns, and the height of the outlet region is 75-125 microns.

Reference is now made to FIGS. 10A, 10B, and 10C, which are schematic illustrations of portions of pump system 150 that is configured to interact with fluidic channels 120, 122, and 124 of sample carrier 22, in accordance with some applications of the present invention. Typically, pump system 150 is housed within optical-measurement unit 31. For some applications, pump system includes a pump, such as a piston pump 152, shown in FIG. 10A. As described hereinabove, the pump system is typically configured to interact with one or more ports of the sample carrier, e.g., one or more of ports 62, 64, 66 shown in FIGS. 5A-D. To this end, for some applications, the pump system includes one or more valves 154 that are fluidically coupled with tubes 156, as shown in FIG. 10B. In turn, the tubes are configured to be inserted into respective ports of the sample carrier when the sample carrier is housed within the optical-measurement unit (e.g., when the sample carrier is disposed upon stage 42 (shown in FIG. 2B) of the optical-measurement unit). For some applications, the pump system includes a further valve 158, which is configured to either connect pump 152 to valve(s) 154 or to ambient air depending on the stage of operation of the pump system with respect to valve(s) 154. Typically, the pump system is configured to perform one or more of the following functionalities with respect to one or more of ports 62, 64, 66: (a) apply positive pressure, (b) apply vacuum pressure, (c) prevent any pressure being applied to the port, and/or (d) expose the port to ambient pressure. As noted hereinabove, for some applications, the pump system can be configured as a volumetric pump that is configured to pump a predetermined volume of fluid into (or out of) a port.

Referring to FIG. 10C, for some applications, pump system 150 includes a relative pressure gauge 160 i.e., a gauge that measures the pressure difference between the pressure inside a vessel relative to the ambient pressure. Gauge 160 is typically configured to measure the pressure difference between a portion of pump system 150 and ambient pressure. (It is noted that the terms “ambient pressure” and “atmospheric pressure” are used interchangeably herein.) As noted hereinabove, typically pump system is configured to perform volumetric pumping, typically relying on a piston to apply pressure by moving such as to pump air from or into a given volume within the pumping system. For some applications, the computer processor derives ambient pressure using the pressure difference between a portion of pump system 150 and ambient pressure (as measured using gauge 160), in combination with the volumetric pump system. For some applications, the computer processor, thereby derives ambient pressure without requiring a direct measurement of ambient pressure. For example, the computer processor may derive ambient pressure by sealing a portion of the pumping system having a known volume and initially applying no pressure, such that the sealed portion of the pumping system is at ambient pressure. (It is noted that, in this context, the portion of the pumping system having the known volume may include a portion of one or more of the fluidic channels.) The piston is then used to reduce the volume of the sealed portion of the pumping system by a predefined amount. Since pressure multiplied by volume within the sealed portion of the pump system must remain constant, ambient pressure can be derived from the following equation:

P0=((P0+dP)*(V0−dV))/V0, where:
P0 is ambient pressure,
dP is the pressure change (which is measured by gauge 160),
V0 is the starting volume of the portion of the pump system (which is known),
dV is the volume change (which is known, since the pump system is volumetric).

For some applications, the computer processor applies a correction to one or more of the functions described hereinabove, based upon the derived ambient pressure. Typically, this correction functions as an altitude correction since the system being placed at different altitudes is typically what causes variation in the ambient pressure. For some applications, when a volumetric pump as described herein is used to generate pressure changes (e.g., using the apparatus and methods described hereinabove, whereby the movement of the portions of the sample depends on pressure changes), the system is sensitive to ambient pressure. Typically, the lower the ambient pressure, the greater the volume that must be pumped (e.g., by moving the piston a greater distance) to obtain the same pressure difference (and vice versa). For some applications, the internal volumes of the system are predetermined. In addition, volumes that change dynamically depending on pressure (such as that of blister pack 92) are predetermined. The known volumes and dynamically-changing volumes are used to build a model that predicts the pressure buildup for a given change in pump volume (e.g., for a given distance that is moved by the piston) given the absolute ambient pressure. For some applications, in this manner, the pump motion sequence that is required to produce an entire sequence defined by pressures is determined. For some alternative applications, the system uses a closed-loop algorithm whereby the pressure within the pump system is measured constantly, in order to determine which real-time pressure changes are required. However, this introduces a complexity that is avoided in the previously-described algorithm.

For some applications, the mixing process described hereinabove is monitored in accordance with the following technique. Typically, pressure differences are monitored (and typically constantly) during the sample preparation sequence. For some applications, the sample is rejected if certain target pressures are not obtained precisely enough, or if the sequence deviates from a standard reference sequence (e.g., based on a given metric that is to determine difference between uni-dimensional traces, such as sum of square differences). For some applications, the reference sequence is determined for a given optical measurement unit or a given batch of sample carriers. For some applications, a similar technique is used to monitor the optical measurement unit performance over time, by regularly running sequences (e.g., not as part of the normal operation) when air is pressurized (or depressurized), to thereby detect air leaks and blockage (which will typically result in a deteriorated flow rate).

For some applications, blood movement within the sample carrier during handling by a user is controlled. A liquid bodily sample (e.g., blood sample) is collected into the sample carrier by capillary action, as described hereinabove. Typically, as the sample carrier is handled the sample experiences accelerations that may result in movement inside the sample carrier, which could in turn lead to undesired effects (e.g., due to the user walking while holding the sample carrier and/or placing the sample carrier at different orientations). For some applications, the sample carrier includes features that limit or prevent said movement, for example, by the design of the geometry of the fluidic channels, use of hydrophobic surfaces, and/or sealing of the ends of fluidic channels (subsequent to sample collection), e.g., as described hereinabove.

In general, it is noted that although some applications of the present invention have been described with respect to a blood sample, the scope of the present invention includes applying the apparatus and methods described herein to a variety of samples. As described hereinabove, for some applications, the sample is a fine needle aspirate. For some applications, the sample is a bodily sample, such as, blood, saliva, semen, sweat, sputum, vaginal fluid, stool, breast milk, bronchoalveolar lavage, gastric lavage, tears and/or nasal discharge. The bodily sample may be from any living creature, and is typically from warm blooded animals. For some applications, the bodily sample is a sample from a mammal, e.g., from a human body. For some applications, the sample is taken from any domestic animal, zoo animals and farm animals, including but not limited to dogs, cats, horses, cows and sheep. Alternatively or additionally, the bodily sample is taken from animals that act as disease vectors including deer or rats.

For some applications, similar techniques to those described hereinabove are applied to a non-bodily sample. For some applications, the sample is an environmental sample, such as, a water (e.g., groundwater) sample, surface swab, soil sample, air sample, or any combination thereof. In some embodiments, the sample is a food sample, such as, a meat sample, dairy sample, water sample, wash-liquid sample, beverage sample, and/or any combination thereof.

Applications of the invention described herein can take the form of a computer program product accessible from a computer-usable or computer-readable medium (e.g., a non-transitory computer-readable medium) providing program code for use by or in connection with a computer or any instruction execution system, such as computer processor 28. For the purposes of this description, a computer-usable or computer readable medium can be any apparatus that can comprise, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Typically, the computer-usable or computer readable medium is a non-transitory computer-usable or computer readable medium.

Examples of a computer-readable medium include a semiconductor or solid state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD. A data processing system suitable for storing and/or executing program code will include at least one processor (e.g., computer processor 28) coupled directly or indirectly to memory elements (e.g., memory 30) through a system bus. The memory elements can include local memory employed during actual execution of the program code, bulk storage, and cache memories which provide temporary storage of at least some program code in order to reduce the number of times code must be retrieved from bulk storage during execution. The system can read the inventive instructions on the program storage devices and follow these instructions to execute the methodology of the embodiments of the invention.

Network adapters may be coupled to the processor to enable the processor to become coupled to other processors or remote printers or storage devices through intervening private or public networks. Modems, cable modem and Ethernet cards are just a few of the currently available types of network adapters.

Computer program code for carrying out operations of the present invention may be written in any combination of one or more programming languages, including an object-oriented programming language such as Java, Smalltalk, C++or the like and conventional procedural programming languages, such as the C programming language or similar programming languages.

It will be understood that algorithms described herein, can be implemented by computer program instructions. These computer program instructions may be provided to a processor of a general-purpose computer, special purpose computer, or other programmable data processing apparatus to produce a machine, such that the instructions, which execute via the processor of the computer (e.g., computer processor 28) or other programmable data processing apparatus, create means for implementing the functions/acts specified in the algorithms described in the present application. These computer program instructions may also be stored in a computer-readable medium (e.g., a non-transitory computer-readable medium) that can direct a computer or other programmable data processing apparatus to function in a particular manner, such that the instructions stored in the computer-readable medium produce an article of manufacture including instruction means which implement the function/act specified in the flowchart blocks and algorithms. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the algorithms described in the present application.

Computer processor 28 is typically a hardware device programmed with computer program instructions to produce a special purpose computer. For example, when programmed to perform the algorithms described herein, computer processor 28 typically acts as a special purpose sample-analysis computer processor. Typically, the operations described herein that are performed by computer processor 28 transform the physical state of memory 30, which is a real physical article, to have a different magnetic polarity, electrical charge, or the like depending on the technology of the memory that is used.

The apparatus and methods described herein may be used in conjunction with apparatus and methods described in any one of the following patents or patent applications, all of which are incorporated herein by reference:
U.S. Pat. No. 9,522,396 to Bachelet;
U.S. Pat. No. 10,176,565 to Greenfield;
U.S. Pat. No. 10,640,807 to Pollak;
U.S. Pat. No. 9,329,129 to Pollak;
U.S. Pat. No. 10,093,957 to Pollak;
U.S. Pat. No. 10,831,013 to Yorav Raphael;
U.S. Pat. No. 10,843,190 to Bachelet;
U.S. Pat. No. 10,482,595 to Yorav Raphael;
U.S. Pat. No. 10,488,644 to Eshel;
US 2020/0300750 to Eshel;
U.S. Pat. No. 11,307,196 to Pollak;
U.S. Pat. No. 11,099,175 to Zait;
US 2020/0386976 to Yorav-Raphael;
US 2022/0390372 to Pecker;
US 2022/0381672 to Pecker;
US 2023/0003622 to Yafin;
WO 21/116957 to Gluck;
US 2022-0299436 to Franklin;
WO 21/116960 to Zait; and
WO 21/116962 to Halperin.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1. Apparatus for analyzing a bodily sample, the apparatus comprising:
a sample carrier configured to house the bodily sample, the sample carrier comprising at least one fluidic channel, at least one analysis chamber, and a receptacle that houses a diluent; and
a pump system configured to:
pump the diluent from the receptacle into the fluidic channel in a first fluid flow direction, and
subsequently, pump the diluent and the bodily sample in a second fluid flow direction, which is a reverse of the first fluid flow direction, to thereby mix the diluent and the bodily sample within the receptacle.

2. The apparatus according to claim 1, wherein the sample carrier is configured to be placed within an optical measurement unit that is configured to perform an optical measurement upon the bodily sample while the sample carrier is disposed within the optical measurement unit, and wherein the pump system is disposed within the optical measurement unit.

3. The apparatus according to claim 1, wherein the fluidic channel and the receptacle are configured such that, as the diluent and the bodily sample are pumped in the second fluid flow direction, the diluent and the bodily sample are pumped from a smaller cross-sectional area within the fluidic channel into a larger cross-sectional area within the receptacle, thereby enhancing mixing of the diluent and the bodily sample.

4. The apparatus according to claim 1, wherein the fluidic channel is configured such that, as the diluent and the bodily sample are pumped in the first fluid flow direction, the diluent and the bodily sample are pumped from a smaller cross-sectional area within the fluidic channel into a larger cross-sectional area within the fluidic channel, thereby enhancing mixing of the diluent and the bodily sample.

5. The apparatus according to claim 1, wherein the receptacle comprises a blister pack and wherein the sample carrier comprises a needle that is configured to release the diluent from the blister pack, by piercing the blister pack.

6. The apparatus according to claim 5, wherein the blister pack is disposed at an angle within the sample carrier such that the blister pack acts as a bubble trap, by preventing air from being pumped from the blister pack.

7. The apparatus according to claim 5, wherein the needle is hollow and the fluidic channel extends through the needle.

8. The apparatus according to claim 5, wherein the sample carrier comprises a cap and a main body, wherein the blister pack is disposed within the main body, and wherein the needle is coupled to the cap and is configured to pierce the blister pack as the cap is coupled to the main body of the sample carrier.

9. The apparatus according to claim 8, wherein the fluidic channel extends from the blister pack through the cap and back into the main body of the sample carrier.

10. The apparatus according to claim 9, further comprising one or more stains that are configured to stain the bodily sample and that are disposed within the cap, wherein the cap is configured such that as the diluent flows out of the blister pack, the diluent mixes with the stain and the diluent and the stain mix with the bodily sample.

11. Apparatus for analyzing a bodily sample, the apparatus comprising:
a sample carrier configured to house the bodily sample, the sample carrier comprising at least one fluidic channel, and at least one analysis chamber; and
an optical measurement unit comprising:
a stage that is configured to hold the sample carrier;
an optical measurement device that is configured to perform optical measurements on a portion of the bodily sample that is disposed in the analysis chamber, when the sample carrier is held by the stage; and
a pump system comprising one or more pumps that are configured to pump the bodily sample through the fluidic channel.

12. The apparatus according to claim 11, wherein the pump system is configured to apply any one of ambient pressure, positive pressure, vacuum pressure, or to apply no pressure to the fluidic channel.

13. The apparatus according to claim 11, wherein the sample carrier comprises a microscope analysis chamber and a first fluidic channel that extends to the microscope analysis chamber, and wherein the optical measurement device comprises a microscope configured to image a first portion of the bodily sample, when the first portion of the bodily sample is disposed within the microscopic analysis chamber.

14. (canceled)

15. The apparatus according to claim 13, wherein:
the sample carrier comprises an optical-density-analysis chamber and a second fluidic channel that extends to the optical-density-analysis chamber;
the optical measurement device further comprises an optical-density-measurement device configured to perform optical density measurements on a second portion of the bodily sample, when the second portion of the bodily sample is disposed within the optical-density-analysis chamber; and
the pump system is configured to pump the first and second portions of the bodily sample through the first and second fluidic channels respectively.

16-17. (canceled)

18. The apparatus according to claim 13, wherein the microscope analysis chamber comprises an inlet and an outlet, wherein the sample carrier comprises an additional fluidic channel, and wherein the pump system is configured to balance pressure between the inlet and the outlet of the microscope analysis chamber via the first fluidic channel and the additional fluidic channel.

19. The apparatus according to claim 18, wherein the pump system is configured to balance pressure between the inlet and the outlet of the microscope analysis chamber by exposing the first fluidic channel and the additional fluidic channel to atmospheric pressure.

20. The apparatus according to claim 18, wherein the pump system is configured to balance pressure between the inlet and the outlet of the microscope analysis chamber by applying equal amounts of pressure via the first fluidic channel and the additional fluidic channel.

21. The apparatus according to claim 11, wherein the pump system comprises a volumetric pump system that comprises a piston that is configured to pump defined volumes of air through the fluidic channel.

22. The apparatus according to claim 21, wherein the pump system comprises a relative pressure gauge that is configured to measure pressure of a portion of the pump system relative to ambient pressure, and wherein the optical measurement unit comprises a computer processor that is configured to derive ambient pressure from the pressure that is measured by the relative pressure gauge.

23. The apparatus according to claim 22, wherein the computer processor is configured to determine a volume that should be pumped by the piston in order to provide a desired pressure change, based upon the ambient pressure.

24-72. (canceled)
